(19) United States
(12) Patent Application Publication
(10) Pub. No.: US 2013/0251983 A1
(43) Pub. Date: Sep. 26, 2013

(54) COATING FORMING COMPOSITION USED FOR FORMING TRANSPARENT CONDUCTIVE FILM

(71) Applicant: JNC CORPORATION, Tokyo (JP)

(72) Inventors: YASUHIRO KONDO, CHIBA (JP); MOTOKI YANAI, CHIBA (JP); SETSUO ITAMI, CHIBA (JP)

(73) Assignee: JNC CORPORATION, TOKYO (JP)

(21) Appl. No.: 13/802,800

(22) Filed: Mar. 14, 2013

(30) Foreign Application Priority Data
Mar. 21, 2012 (JP) 2012-063103

(51) Int. Cl. H01B 1/02

(52) U.S. Cl. CPC H01B 1/02
USPC 428/336; 252/514

(57) ABSTRACT

To provide a material capable of obtaining a transparent conductive film having an excellent conductivity, Optical transmission, Environmental reliability, suitability for process, adhesion and hardness in a single application process, and to provide a transparent conductive film using the same and a device element using the same. A coating forming composition containing at least one kind selected from the group of metal nanowires and metal nanotubes as a first component, a polymer compound having a hydroxyl group as a second component, a compound having a group 13 element or a transition metal element as a third component, and further a solvent is prepared to obtain a transparent conductive film by the coating.

### CROSS-REFERENCE TO RELATED APPLICATIONS

This application claims the priority benefit of Japan application serial no. 2012-063103, filed on Mar. 21, 2012. The entirety of the above-mentioned patent application is hereby incorporated by reference herein and made a part of this specification.

### TECHNICAL FIELD

The present invention relates to a coating forming composition. More specifically, the invention relates to a method for manufacturing a substrate having a transparent conductive film that can be obtained from the composition, and is excellent in conductivity, Optical transmission, Environmental reliability, suitability for process and pencil hardness, and a device element using the substrate.

### BACKGROUND ART

A transparent conductive film is used in various fields such as a transparent electrode for a liquid crystal display (LCD), a plasma display panel (PDP), an organic electroluminescence display, a photovoltaic (PV) cell and a touch panel (TP), an electrostatic discharge (ESD) film and an electromagnetic interference (EMI) film, and (1) a low surface resistance, (2) a high Optical transmittance and (3) a high reliability are required.

To the transparent conductive film used for the transparent electrodes, indium tin oxide (ITO) has been applied so far.

However, indium used for ITO includes a problem of supply anxiety and price soaring. Moreover, a sputtering method needing a high vacuum is applied to forming an ITO film. Therefore, a scale of manufacturing equipment becomes large, resulting in a long manufacturing time and a high cost. Furthermore, the ITO film easily breaks by generating a crack due to a physical stress such as bending. Upon sputtering the ITO film, a large amount of heat is developed, and therefore a polymer on a flexible substrate is damaged. Application of the sputtering method to a substrate provided with flexibility is difficult. Therefore, a search has been actively promoted for an ITO substitute material in which the problems are solved.

Consequently, specific examples of a material allowing application and film formation without needing sputtering among kinds of “ITO substitute materials” have been reported, including (i) a polymer conductive material such as poly(3,4-ethylenedioxythiophene)-poly(4-styrenesulfonate) (PEDOT: PSS) (see Patent literature No. 1), (ii) a conductive material containing metal nanowires (see Patent literature No. 2 and Non-patent literature No. 1), (iii) a conductive material including a random network structure by fine silver particles (see Patent literature No. 3), (iv) a conductive material containing a conductive component having nanostructure, such as a conductive material containing carbon nanotubes (see Patent literature No. 4), and (v) a conductive material including a fine mesh using metal fine wiring (see Patent literature No. 5).

However, the material disclosed in (i) has a disadvantage of a low Optical transmittance and a poor Environmental reliability because the conductive material includes organic molecules, the material disclosed in (iii) has a disadvantage of a complex process because the transparent conductive film is prepared using self-organization, the material disclosed in (iv) has a disadvantage of a blackish color due to the carbon nanotubes and a reduced Optical transmittance, and the material disclosed in (v) has a disadvantage of impossibility of utilizing a conventional process because a photographic technology is applied.

Among the materials, the conductive material containing the metal nanowires disclosed in (ii) is optimum for “ITO substitute material” because the conductive material is reported to show a low surface resistance and a high Optical transmittance (see Patent literature No. 2 and Non-patent literature No. 1, for example), and has also flexibility.

On the other hand, because the metal nanowires disclosed in (ii) are very fine, a coating is weak and easily scratched, and conductivity thereof tends to be lost by a minute scratch.

Thus, a low hardness of the coating causes a problem in a conventional general manufacturing process or in use.

In a manufacturing process, for example, the transparent conductive film is applied onto a substrate or a film according to a use and sent to a subsequent process. However, the transparent conductive film may be occasionally scratched in a transport process or a physical cleaning process and become unusable.

In use, when the transparent conductive film is applied to a resistive touch panel, for example, a position is detected by bringing an upper or lower transparent conductive film into contact with a finger or a pen. When such an operation is repeated, the transparent conductive film may be occasionally scratched and reliability of a device may be occasionally decreased. Moreover, when the transparent conductive film is used for a capacitive touch panel, formation of a protective layer or an overcoat on the transparent conductive film causes a decrease in electrostatic capacity, leading to a decrease in sensitivity of the touch panel.

The protective layer or the overcoat may be occasionally provided on the transparent conductive film for improving coating hardness. If an insulating film is applied onto the transparent conductive film, electrical connection through a protective film cannot be made. Thus, such a configuration is not used for the resistive touch panel. Furthermore, in a process for forming the protective layer or the overcoat, formation of the protective layer or the overcoat may give a thermal or chemical damage to a lower transparent conductive film, and transparency or conductivity characteristics may be lost. Furthermore, the protective layer or the overcoat should be formed separately from the transparent conductive film. Thus, a disadvantage of increasing the number of processes is also caused.

An attempt has been made to add a conductive compound to the protective layer and keep conductivity through the protective film. However, addition of the conductive compound to a component of the protective film is considered to cause formation of a fragile protective film or reduction in electro-optical characteristics of the protective film.

In the film forming composition as described in Patent literature No. 2, no crosslinkable compound is used. Therefore, suitability for process of the composition is considered to be poor. Moreover, in the transparent conductive films as described in Patent literatures Nos. 6 and 7, a transparent conductive film using silver nanowires is formed as a first layer, an organic conductive material is formed in a second layer, and a crosslikable compound is added to one of the layers. According to the method, Environmental reliability is considered to be low due to the organic conductive material. Moreover, the number of processes increases because formation of two layers is essential.

Accordingly, an ITO substitute transparent conductive film is required in which the ITO substitute transparent film is excellent in (1) conductivity, (2) Optical transmission and (3) pencil hardness, and the conventional general process can be applied.

### REFERENCE LIST

### Patent Literature

Patent literature No. 1: JP 2004-59666 A.
Patent literature No. 2: JP 2009-505358 A.
Patent literature No. 3: JP 2008-78441 A.
Patent literature No. 4: JP 2007-112133 A.
Patent literature No. 5: JP 2007-270353 A.
Patent literature No. 6: JP 2010-244747 A.
Patent literature No. 7: JP 2010-205532 A.

### Non-Patent Literature

Non-patent literature No. 1: Shih-Hsiang Lai, Chun-Yao Ou, “SID 08 DIGEST,” 2008, pp. 1200-1202.

### SUMMARY OF INVENTION

The invention concerns a coating forming composition, containing at least one kind selected from the group of metal nanowires and metal nanotubes as a first component; a polymer compound having a hydroxyl group as a second component; at least one kind selected from hydroxide containing a group 13 element or a transition metal element, acylate containing a group 13 element or a transition metal element, alkoxide containing a group 13 element or a transition metal element, and a complex containing a group 13 element or a transition metal element as a third component; and a solvent.

The invention also concerns a substrate having a transparent conductive film obtained using the coating forming composition, wherein a thickness of the transparent conductive film is in the range of 5 nanometers to 500 nanometers, a surface resistance of the transparent conductive film is in the range of 10 ohms/square (hereinafter, occasionally expressed in terms of Ω/□ for ohms/square) to 5,000Ω/□, and a total transmittance of the transparent conductive film is 85% or more.

The invention further concerns a device element using the substrate.

### DESCRIPTION OF EMBODIMENTS

### Technical Problem

An object of the invention is to prepare a coating forming composition that is excellent in dispersion stability and storage stability of a conductive component in a solution, and to provide a composition capable of forming in a single application process using the composition a coating that is excellent in conductivity, Optical transmission and pencil hardness.

### Solution to Problem

The present inventors have diligently continued to conduct research for a component of a composition for forming a transparent conductive film, as a result, have found that metal nanowires or metal nanotubes are favorably dispersed in a coating forming composition containing the metal nanowires and the metal nanotubes, polysaccharide being a polymer compound having a hydroxyl group and a derivative of the polysaccharides, a polymer having a hydroxyl group, a compound having a group 13 element or a transition metal element and also a solvent, and also found that a transparent conductive film that is excellent in conductivity, Optical transmission and pencil hardness can be formed from the composition in a conventional general single application process by crosslinking the hydroxyl groups of the polymer compound having the hydroxyl group with the compound having the group 13 element or the transition metal element.

The invention concerns items 1 to 14 as described below, for example.

Item 1. A coating forming composition, containing at least one kind selected from the group of metal nanowires and metal nanotubes as a first component; a polymer compound having a hydroxyl group as a second component; at least one kind selected from hydroxide containing a group 13 element or a transition metal element, acylate containing a group 13 element or a transition metal element, alkoxide containing a group 13 element or a transition metal element and a complex containing a group 13 element or a transition metal element as a third component; and a solvent.
Item 2. The coating forming composition according to item 1, wherein the third component is at least one kind selected from the group of alkoxide containing a transition metal element, acylate containing a transition metal element and a complex containing a transition metal element.
Item 3. The coating forming composition according to item 2, wherein the transition metal of the third component is titanium.
Item 4. The coating forming composition according to any one of items 1 to 3, wherein the second component contains at least one kind selected from the group of a homopolymer of vinyl alcohol and a copolymer thereof, a homopolymer of hydroxyalkyl(meth)acrylate and a copolymer thereof, a homopolymer of hydroxyalkyl(meth)acrylamide and a copolymer thereof, and polysaccharides and a derivative thereof.
Item 5. The coating forming composition according to item 4, wherein the second component contains at least one kind selected from the group of polysaccharides and a derivative thereof, and a homopolymer of vinyl alcohol and a copolymer thereof.
Item 6. The coating forming composition according to item 5, wherein the second component contains at least one kind selected from the group of polysaccharides and a derivative thereof, and at least one kind selected from the group of a homopolymer of vinyl alcohol and a copolymer thereof.
Item 7. The coating forming composition according to any one of items 1 to 6, wherein the first component is in the range of 0.01% by weight to 1.0% by weight, the second component is in the range of 0.0050% by weight to 5.0% by weight, the third component is in the range of 0.000050% by weight to 5.0% by weight, and the solvent is in the range of 89.0% by weight to 99.98% by weight, based on the total weight of the coating forming composition.
Item 8. The coating forming composition according to any one of items 1 to 7, further containing at least one kind selected from the group of an isocyanate compound, an epoxy compound, an aldehyde compound, an amine compound and a methylol compound, as a fourth component.
Item 9. The coating forming composition according to item 8, containing a methylol compound as the fourth component.
Item 10. The coating forming composition according to item 8 or 9, wherein the first component is in the range of 0.01% by weight to 1.0% by weight, the second component is in the range of 0.0050% by weight to 5.0% by weight, the third component is in the range of 0.000050% by weight to 5.0% by weight, the fourth component is in the range of 0.000050% by weight to 5.0% by weight, and the solvent is in the range of 84.0% by weight to 99.98% by weight, based on the total weight of the coating forming composition.
Item 11. The coating forming composition according to any one of items 1 to 10, wherein the first component is silver nanowires.
Item 12. The coating forming composition according to any one of items 1 to 11, used for forming a coating having conductivity.
Item 13. A substrate having a transparent conductive film obtained using the coating forming composition according to item 12, wherein a thickness of the transparent conductive film is in the range of 5 nanometers to 500 nanometers, a surface resistance of the transparent conductive film is in the range of 10Ω/□ to 5,000Ω/□, and a total transmittance of the transparent conductive film is 85% or more.
Item 14. A device element, using the substrate according to item 13.

### Advantageous Effects of Invention

According to the invention, a composition in which metal nanowires or metal nanotubes are favorably dispersed is obtained. Moreover, a coating that is excellent in conductivity, Optical transmission, Environmental reliability and pencil hardness can be formed by applying the composition onto a substrate in manufacturing a transparent conductive film. Moreover, the thus obtained transparent conductive film can have both a low surface resistance value and good optical characteristics such as a good Optical transmittance.

Hereinafter, the invention will be specifically explained.

“Transparent conductive film” herein means a film having a surface resistance of approximately 10⁴Ω/□ or less, and a total transmittance of approximately 80% or more. “Binder” means a resin used for allowing a conductive material of metal nanowires or metal nanotubes to disperse into a conductive film and to support the conductive material thereon.

### 1. Coating Forming Composition

A coating forming composition of the invention contains at least one kind selected from the group of metal nanowires and metal nanotubes (hereinafter, occasionally referred to as the metal nanowires and the metal nanotubes) as a first component, a polymer compound having a hydroxyl group as a second component, a compound having a group 13 element or a transition metal element as a third component, and further a solvent.

### 1-1. First Component: Metal Nanowires and Metal Nanotubes

The coating forming composition of the invention contains at least one kind selected from the group of metal nanowires and metal nanotubes as the first component. The first component forms a network in a coating obtained from the composition of the invention and provides the coating with conductivity.

“Metal nanowires” herein means a conductive material having a wire shape, and the metal nanowires may be linear, or gently or steeply bent. The metal nanowires may also be flexible or rigid.

“Metal nanotubes” herein means a porous or nonporous conductive material having a tubular shape, and the metal nanotubes may be linear, or gently or steeply bent. Properties may be flexible or rigid.

Either the metal nanowires or the metal nanotubes may be used, or both may be mixed and used.

Specific examples of kinds of metals include at least one kind selected from the group of gold, silver, platinum, copper, nickel, iron, cobalt, zinc, ruthenium, rhodium, palladium, cadmium, osmium and iridium, and an alloy obtained by combining the metals. From a viewpoint of obtaining a coating having a low surface resistance and a high total transmittance, at least one kind of any of gold, silver and copper is preferably contained. The metals have a high conductivity, and therefore density of the metal on a surface can be reduced upon obtaining a desired surface resistance, and thus a high transmittance can be realized. Above all, at least one kind of gold or silver is further preferably contained. As an optimum aspect, silver is preferred.

A length of the first component in a minor axis in the coating forming composition, a length thereof in a major axis and an aspect ratio thereof have a fixed distribution. The distribution is selected from a viewpoint in which the coating obtained from the composition of the invention becomes high in the total transmittance and low in the surface resistance. Specifically, a mean of the length of the first component in the minor axis is preferably in the range of approximately 1 nanometer to approximately 500 nanometers, further preferably, approximately 5 nanometers to approximately 200 nanometers, still further preferably, in the range of approximately 5 nanometers to approximately 100 nanometers, particularly preferably, in the range of approximately 10 nanometers to approximately 100 nanometers. Moreover, a mean of the length of the first component in the major axis is preferably in the range of approximately 1 micrometer to approximately 100 micrometers, further preferably, in the range of approximately 1 micrometer to approximately 50 micrometers, still further preferably, in the range of approximately 2 micrometers to approximately 50 micrometers, particularly preferably, in the range of approximately 5 micrometers to approximately 30 micrometers. As the first component, the mean of the length thereof in the minor axis and the mean of the length thereof in the major axis satisfy the ranges described above, and a mean of the aspect ratio is preferably approximately 1 or more, further preferably, approximately 10 or more, still further preferably, approximately 100 or more, particularly preferably, approximately 200 or more. Herein, “aspect ratio” is expressed in terms of a value determined from an equation: a/b, when an average length of the first component in the minor axis is approximated as “b,” and an average length of the first component in the major axis is approximated as “a.” Then, “a” and “b” can be measured using a scanning electron microscope. In the invention, scanning electron microscope SU-70 (made by Hitachi High-Technologies Corporation) has been used.

As a method for manufacturing the first component, a publicly known manufacturing method can be applied. For example, the silver nanowires can be synthesized by reducing silver nitrate in the presence of polyvinylpyrrolidone by applying a polyol process (Chem. Mater., 2002, 14, 4736). Moreover, as described in Patent literature No. 5, the silver nanowires can also be synthesized by reducing silver nitrate through nucleus formation and a double jet process without using polyvinylpyrrolidone.

A diameter of nanowires and a length thereof can be controlled by changing reaction conditions or reducing agents, or adding a salt. The diameter of nanowires and the length thereof are controlled by changing reaction temperatures or reducing agents in WO 2008/073143 A. The diameter can also be controlled by addition of potassium bromide (ACS NANO, 2010, 4, 5, 2955).

Gold nanowires can also be synthesized by reducing chloroaurate hydrate in the presence of polyvinylpyrrolidone in a similar manner (J. Am. Chem. Soc., 2007, 129, 1733). A technology for synthesizing and purifying the silver nanowires and the gold nanowires in a large scale is described in detail in WO 2008/073143 A and WO 2008/046058 A.

Gold nanotubes having a porous structure can be synthesized by using the silver nanowires as a template and according to an electro-less displacement plating reaction with the silver nanowires per se by using a chloroauric acid solution. A surface of the silver nanowires is covered with gold according to the electro-less displacement plating reaction of silver with chloroauric acid. On the other hand, the silver nanowires used as the template are dissolved out into the solution. As a result, the gold nanotubes having the porous structure can be prepared (J. Am. Chem. Soc., 2004, 126, 3892-3901). Moreover, the silver nanowires as the template can also be removed by using an aqueous ammonia solution (ACS NANO, 2009, 3 and 6, 1365-1372).

From a viewpoint of a high conductivity and transparency, content of the first component is preferably in the range of approximately 0.01% by weight to approximately 1.0% by weight, further preferably, in the range of approximately 0.05% by weight to approximately 0.75% by weight, still further preferably, in the range of approximately 0.1% by weight to approximately 0.5% by weight, based on the total weight of the coating forming composition.

### 1-2. Second Component: Polymer Compound Having Hydroxyl Group

The coating forming composition of the invention contains a polymer compound having a hydroxyl group as a second component. The second component provides the first component with dispersibility in an aqueous solvent by increasing a viscosity of the composition. The second component forms a film and simultaneously connects the film formed with the substrate during film formation. Moreover, the second component plays a role of a binder for dispersing and binding any other component in the coating. Furthermore, the second component has a large number of hydroxyl groups in a molecule, and contributes to an increase in pencil hardness by forming crosslinking with the third component during bake. More specifically, the second component is considered to exhibit functions such as a good dispersibility, a high conductivity, a high Optical transmission and a high hardness without adversely affecting dispersibility of the first component in the composition, and without destroying a conductive network formed by the first component of the composition of the invention in the coating obtained from the composition.

As a viscosity of the second component of the invention is higher, a more uniform dispersibility is obtained for a long period of time because precipitation of the metal nanowires and the metal nanotubes is suppressed. Moreover, a higher conductivity is obtained because a higher silver nanowire density with a thicker film is achieved. On the other hand, as the viscosity is lower, roughness and uniformity of the coating are better. Moreover, a higher water resistance and a higher hardness are obtained because intramolecular crosslinking decreases, intermolecular crosslinking increases and complicated crosslinking are formed during crosslinking with the third component. Two or more kinds of the second components having different viscosity may also be used.

Specific examples of the second components of the invention include polysaccharides and a derivative thereof, and a homopolymer of an ethylenic monomer having a hydroxyl group and a copolymer thereof. Moreover, when a plurality of kinds are used, the second component may include only the polysaccharides and the derivative thereof, only the homopolymer of the ethylenic monomer having the hydroxyl group and the copolymer thereof, or a mixture of the polysaccharides and the derivative thereof, and the homopolymer of the ethylenic monomer having the hydroxyl group and the copolymer thereof.

From a viewpoint of a good dispersibility of the second component into the first component in the composition, a high transmittance, film forming properties and adhesion, content of the second component is preferably in the range of approximately 50 parts by weight to approximately 500 parts by weight, further preferably, in the range of approximately 100 parts by weight to approximately 400 parts by weight, still further preferably, in the range of approximately 200 parts by weight to approximately 300 parts by weight, based on 100 parts by weight of the first component. Based on the total weight of the coating forming composition, the content of the second component is preferably in the range of approximately 0.0050% by weight to approximately 5.0% by weight, further preferably, in the range of approximately 0.050% by weight to approximately 3.0% by weight, still further preferably, in the range of approximately 0.2% by weight to approximately 1.5% by weight.

1-2-1. Polysaccharides and derivative thereof.

Specific examples of the polysaccharides and the derivative thereof to be used in the composition of the invention include polysaccharides such as starch, gum arabic, hydroxypropyl methyl cellulose, carboxymethyl cellulose, hydroxyethyl cellulose, methyl hydroxyethyl cellulose, chitosan, dextran, guar gum and glucomannan, and a derivative thereof. Specific examples include preferably polysaccharides such as xanthan gum, hydroxypropyl methyl cellulose, carboxylmethyl cellulose, hydroxyethyl cellulose, methyl hydroxyethyl cellulose, dextran, guar gum and glucomannan, and a derivative thereof, further preferably, a cellulose ether derivative such as hydroxypropyl methyl cellulose, methyl hydroxyethyl cellulose, carboxymethyl cellulose, methyl cellulose and ethyl cellulose, particularly preferably, hydroxypropyl methyl cellulose. In the second component, polysaccharides having a carboxylate, sulfonate, phosphate or the like and a derivative thereof may be a salt with sodium, potassium, calcium, ammonium or the like, and polysaccharides having a nitrogen atom and a derivative thereof may have a structure of hydrochloride, citrate or the like. The second component can be used in one kind or in a plurality of kinds. When using the plurality of kinds, the polysaccharides and the derivative thereof may be only the polysaccharides or only the derivative thereof, or a mixture of the polysaccharides and the derivative thereof.

As a commercial product, Metolose 90SH-100000, Metolose 90SH-30000, Metolose 90SH-15000, Metolose 90SH-4000, Metolose 65SH-15000, Metolose 65SH-4000, Metolose 60SH-10000, Metolose 60SH-4000, Metolose SM-8000 and Metolose SM-4000 (trade names) (made by Shin-Etsu Chemical Co., Ltd.), and Methocel K100M, Methocel K15M, Methocel K4M, Methocel F4M, Methocel E10M and Methocel E4M (trade names) (made by the Dow Chemical Company) can be used, for example.

### 1-2-2. Homopolymer of Ethylenic Monomer Having Hydroxyl Group and Copolymer Thereof

Specific examples of the homopolymer of the ethylenic monomer having the hydroxyl group and the copolymer thereof to be used in the composition of the invention include a homopolymer of vinyl alcohol and a copolymer thereof, a homopolymer of hydroxyalkyl(meth)acrylate and a copolymer thereof, and a homopolymer of hydroxyalkyl(meth)acrylamide and a copolymer thereof. Specific examples include preferably polyvinyl alcohol, acetoacetylated polyvinyl alcohol, polyvinyl formal, polyvinyl acetal, polyvinyl butyral, an ethylene-vinyl acetate-vinyl alcohol copolymer, a homopolymer of hydroxyethyl(meth)acrylate and a copolymer thereof, and a homopolymer of hydroxyethyl(meth)acrylamide and a copolymer thereof, further preferably, polyvinyl alcohol. Moreover, in the second component, a homopolymer of an ethylenic monomer that has a hydroxyl group and a carboxylate, a sulfonate, a phosphate or the like and a copolymer thereof may be a salt with sodium, potassium, calcium, ammonium or the like. A homopolymer of an ethylenic monomer that has a hydroxyl group and a nitrogen atom and a copolymer thereof may have a structure of hydrochloride, citrate or the like. The second component can be used in one kind or in a plurality of kinds. Moreover, when the plurality of kinds are used, the second component may be only the homopolymer of the ethylenic monomer having the hydroxyl group, only the copolymer of the ethylenic monomer having the hydroxyl group, or a mixture of the homopolymer of the ethylenic monomer having the hydroxyl group and the copolymer thereof.

As a commercial product, Gohsenol, Gohsefimer, Gohsenal, Gohseran and Gohsesize (trade names) (The Nippon Synthetic Chemical Industry Co., Ltd.), J-Poval (trade name) (Japan VAM and Poval Co., Ltd.), Kuraray Poval, Eval and TROSIFOL (trade names) (Kuraray Co., Ltd.) and S-Lec (trade name) (Sekisui Chemical Co., Ltd.) can be used, for example.

### 1-3. Third Component: Hydroxide, Acylate, Alkoxide and Complex Each Containing Group 13 Element and Transition Metal Element

The coating forming composition of the invention contains, as the third component, at least one kind selected from the group of hydroxide, acylate, alkoxide and a complex each containing a group 13 element and a transition metal element (namely, the hydroxide containing the group 13 element or the transition metal element, the acylate containing the group 13 element or the transition metal element, the alkoxide containing the group 13 element or the transition metal element, and the complex containing the group 13 element or the transition metal element). The third component reacts with the hydroxyl group of the second component and is crosslinked during bake to reduce water solubility of the second component and simultaneously increase physical strength of the film. Crosslinking uniformly exists wholly in the film, and contributes to increasing strength. The third component causes an increase in physical strength and a decrease in water solubility by crosslinking, and an improvement in Environmental reliability, suitability for process and adhesion as associated therewith without adversely affecting the dispersibility of the first component in the composition and without destroying the network formed by the first component of the composition of the invention in the coating obtained from the composition, and without decreasing the conductivity and the optical characteristics.

A decrease in the water solubility of the film due to crosslinking prevents a water-soluble solvent from penetrating into the film, which prevents a phenomenon (referred to as underetching) in which an etchant is swirled from a side into a lower side of a resist pattern to cause pattern inaccuracy upon etching, and extends an applicable range (margin) of a concentration, temperature or immersion time of the etchant.

Specific examples of “the hydroxide, the acylate, the alkoxide and the complex each containing the group 13 element and the transition metal element” include borax, boronic acid, acylate of boronic acid, alkoxide of boronic acid, a complex of boronic acid, acylate of aluminum, alkoxide of aluminum, a complex of aluminum, alkoxide of a transition metal element, acylate of a transition metal element and a complex of a transition metal element. Specific examples include preferably borax, an aluminum complex, a titanium complex and a zirconium complex, further preferably, titanium lactate. Moreover, the third components may be a salt with sodium, potassium, calcium, ammonium or the like. The third component can be used in one kind or in a plurality of kinds.

Specific examples of the third components of the invention include borax, boric acid, phenylboronic acid, 2-thiopheneboronic acid, methylboronic acid, cis-propenylboronic acid, trans-propenylboronic acid, titanium tetraethoxide, titanium tetra-n-propoxide, titanium tetraisopropoxide, titanium tetra-n-butoxide, titanium tetraisobutoxide, titanium tert-butoxide, titanium lactate, a titanium lactate ammonium salt, zirconium tetraethoxide, zirconium tetrapropoxide, zirconium tetraisopropoxide, zirconium tetrabutoxide, zirconium tetraisobutoxide, aluminum ethoxide, aluminum isopropoxide, aluminum sec-butoxide and aluminum tert-butoxide.

As the third component of the invention, various kinds of commercial products can be used, and may be used in one kind or in combination of two or more kinds.

From a viewpoint of a good dispersibility of the third component into the first component in the composition, a high transmittance, film forming properties, hardness, adhesion and water resistance, content of the third component is preferably in the range of approximately 1 parts by weight to approximately 100 parts by weight, further preferably, in the range of approximately 2.5 parts by weight to approximately 70 parts by weight, still further preferably, in the range of approximately 5 parts by weight to approximately 40 parts by weight, based on 100 parts by weight of the second component. Based on the total weight of the coating forming composition, the content of the third component is preferably in the range of approximately 0.000050% by weight to approximately 5.0% by weight, further preferably, in the range of approximately 0.00125% by weight to approximately 0.525% by weight, still further preferably, in the range of approximately 0.0050% by weight to approximately 0.20% by weight.

As a commercial product, Borax (trade name) (Wako Pure Chemical Industries, Ltd.), Alfine (trade name) (Taimei Chemicals Co., Ltd.), and Orgatix TA-10, Orgatix TA-25, Orgatix TA-22, Orgatix TA-30, Orgatix TC-100, Orgatix TC-401, Orgatix TC-200, Orgatix TC-750, Orgatix TC-400, Orgatix TC-300, Orgatix TC-310, Orgatix TC-315, Orgatix TPHS, Orgatix ZA-45, Orgatix ZA-65, Orgatix ZC-150, Orgatix ZC-540, Orgatix ZC-580, Orgatix ZC-700, Orgatix ZB-320 and Orgatix ZB-126 (trade names) (Matsumoto Fine Chemical Co., Ltd.) can be used, for example.

### 1-4. Fourth Component: Isocyanate Compound, Epoxy Compound, Aldehyde Compound, Amine Compound and Methylol Compound

The coating forming composition of the invention may contain at least one kind selected from the group of the isocyanate compound, the epoxy compound, the aldehyde compound, the amine compound and the methylol compound as the fourth component. The fourth component is crosslinked with the second component and the third component of the invention during bake to reduce water solubility and simultaneously increases physical strength of the film. Crosslinking uniformly exists wholly in the film, and contributes to an increase in strength. The fourth component causes an increase in physical strength and a decrease in water solubility by thermal crosslinking, and an improvement in Environmental reliability, suitability for process and adhesion as associated therewith without adversely affecting the dispersibility of the first component in the composition and without destroying the network formed by the first component of the composition of the invention in the coating obtained from the composition, and without decreasing the conductivity and the optical properties.

In addition, the fourth component does not need to react with all of the second component and third component, and only needs to react with part of the second component and third component.

An electrophilic compound as the fourth component is preferably an isocyanate compound, an epoxy compound, an aldehyde compound, an amine compound and a methylol compound, further preferably, a methylol compound, still further preferably, a protected methylol compound. The coating forming composition of the invention may contain one kind or more kinds of electrophilic compounds.

“Isocyanate compound” herein is a compound having an isocyanate group, a (blocked) isocyanate group in which the isocyanate group is protected by an arbitrary protective group, and an amineimide group being a precursor of the isocyanate group.

“Epoxy compound” herein is a compound having an epoxy group and an oxetanyl group.

“Aldehyde compound” herein is a compound having a formyl group.

“Amine compound” herein is a compound having an amino group, a compound having a protected amino group in which the amino group is protected by a urethane protecting group such as a t-butoxycarbonyl group, a benzyloxycarbonyl group and a fluorenylmethyloxycarbonyl group, and a compound having an amine salt formed by the amino group and an anion.

“Methylol compound” herein is a compound having an N-methylol group and an N-methylol ether group in which the N-methylol group is protected by arbitrary alcohol.

From a viewpoint of Environmental reliability, suitability for process, adhesion and water resistance of the transparent conductive film obtained, content of the fourth component is preferably in the range of approximately 1.0 part by weight to approximately 100 parts by weight, further preferably, in the range of approximately 2.5 parts by weight to approximately 50 parts by weight, still further preferably, in the range of approximately 5.0 parts by weight to approximately 25 parts by weight, based on 100 parts by weight of the total weight of the second component. Based on the total weight of the coating forming composition, the content of the fourth component is preferably in the range of approximately 0.000050% by weight to approximately 5.0% by weight, further preferably, in the range of approximately 0.00128125% by weight to approximately 1.76250% by weight, still further preferably, in the range of approximately 0.010250% by weight to approximately 0.4250% by weight.

### 1-4-1. Isocyanate Compound

Specific examples of the isocyanate compounds that can be used as the fourth component of the invention include hexamethylene diisocyanate, tolylene diisocyanate, isophorone diisocyanate, diphenylmethane diisocyanate, 1,3-bis(isocyanatomethyl)benzene, 1,3-bis(isocyanatomethyl)cyclohexane, 2-isocyanatoethyl(meth)acrylate, 2-(O-[1′-methylpropylideneamino]carboxyamino)ethyl methacrylate, 2-[(3,5-dimethylpyrazolyl)carbonylamino]ethyl methacrylate, 1,1-(bisacryloyloxymethyl)ethyl isocyanate, a compound in which the isocyanate group of the compound described above is protected, a compound prepared by adopting the compound described above as one component, and a mixture thereof.

As the isocyanate compound that can be used as the fourth component of the invention, various kinds of commercial products can be used. Specific examples include Takenate 500 and Takenate 600 (trade names) (Mitsui Chemicals, Inc.), Duranate 24A-100, Duranate 21S-75E, Duranate 22A-75PX, Duranate 18H-70B, Duranate TPA-100, Duranate MFA-75B, Duranate TSA-100, Duranate TLA-100, Duranate TSE-100, Duranate TSS-100, Duranate TKA-100, Duranate MHG-80B, Duranate TSE-100, Duranate E402-90T, Duranate P301-75E, Duranate E405-80T, Duranate D101, Duranate D201, Duranate 17B-60PX, Duranate MF-B60X, Duranate E402-B80T, Duranate TPA-B80E, Duranate MF-K60X, Duranate WB40-100, Duranate WB40-80D, Duranate WE50-100, Duranate WT30-100, Duranate WT20-100 and Duranate 50M-HDI (trade names) (Asahi Kasei Corporation), Elastron BN-69, Elastron BN-37, Elastron BN-45, Elastron BN-77, Elastron BN-04, Elastron BN-27, Elastron BN-11, Elastron E-37, Elastron H-3, Elastron BAP, Elastron C-9, Elastron C-52, Elastron F-29, Elastron H-38, Elastron MF-9, Elastron MF-25K, Elastron MC, Elastron NEW BAP-15, Elastron TP-265, Elastron W-11P, Elastron W-22 and Elastron S-24 (trade names) (Dai-Ichi Kogyo Seiyaku Co., Ltd.), Karenz MOI, Karenz AOI, Karenz MOI-BM, Karenz MOI-BP and Karenz BEI (trade names) (Showa Denko K.K.), and Trixene Blocked Isocyanates 214, Trixene Blocked Isocyanates 7986, Trixene Blocked Isocyanates 327, Trixene Blocked Isocyanates 7950, Trixene Blocked Isocyanates 7951, Trixene Blocked Isocyanates 7960, Trixene Blocked Isocyanates 7961 and Trixene Blocked Isocyanates 7982 and Trixene Blocked Isocyanates 7990, Trixene Blocked Isocyanates 7991 and Trixene Blocked Isocyanates 7992 (trade names) (Baxenden Chemicals Limited).

The isocyanate compounds may be used in one kind or in combination of two or more kinds.

### 1-4-2. Epoxy Compound

Specific examples of the epoxy compounds that can be used as the fourth component of the invention include a phenol novolak, cresol novolak, bisphenol A, bisphenol F, hydrogenated bisphenol A, hydrogenated bisphenol F, bisphenol 5, trisphenol methane, tetraphenol ethane, bixylenol or biphenol epoxy compound, an alicyclic or heterocyclic epoxy compound, an epoxy compound having a dicyclopentadiene or naphthalene structure, a homopolymer of N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenylmethane, a homopolymer of glycidyl methacrylate, a copolymer of glycidyl methacrylate and any other radically polymerizable and monofunctional monomer, a homopolymer of 3-ethyl-3-methacryloyloxymethyloxetane, and a copolymer of 3-ethyl-3-methacryloyloxymethyloxetane and any other radically polymerizable monofunctional monomer.

As the epoxy compound that can be used as the fourth component of the invention, various kinds of commercial products can be used. Specific examples include TECHMORE VG3101L (trade name) (Mitsui Chemicals, Inc.), jER828, jER834, jER1001, jER1004, jER152, jER154, jER807, YL-933, YL-6056, YX-4000, YL-6121 and JER157S (trade names) (Mitsubishi Chemical Corporation), YL-931 (trade name) (Mitsubishi Chemical Corporation), Epiclon 840, Epiclon 850, Epiclon 1050, Epiclon 2055, Epiclon N-730, Epiclon N-770, Epiclon N-865, Epiclon 830, EXA-1514, HP-4032, EXA-4750, EXA-4700, HP-7200, HP-7200H and HP-7200HH (trade names) (DIC Corporation), Epotohto YD-011, Epotohto YD-013, Epotohto YD-127, Epotohto YD-128, Epotohto YDCN-701, Epotohto YDCN-704, Epotohto YDF-170, Epotohto ST-2004, Epotohto ST-2007 and Epotohto ST-3000 (trade names) (Nippon Steel Chemical Co., Ltd.), D.E.R.317, D.E.R.331, D.E.R.661, D.E.R.664, D.E.R.431 and D.E.R.438 (trade names) (the Dow Chemical Co.), Araldite 6071, Araldite 6084, Araldite GY250, Araldite GY260, Araldite ECN1235, Araldite ECN1273, Araldite ECN1299, YDF-175, YDF-2001, YDF-2004, Araldite XPY306, Araldite CY175, Araldite CY179, Araldite PT810 and Araldite 163 (trade names) (BASF Japan, Inc.), Sumi-epoxy ESA-011, Sumi-epoxy ESA-014, Sumi-epoxy ELA-115, Sumi-epoxy ELA-128, Sumi-epoxy ESCN-195× and Sumi-epoxy ESCN-220 (trade names) (Sumitomo Chemical Co., Ltd.), A.E.R.330, A.E.R.331, A.E.R.661 and A.E.R.664 (trade names) (Asahi Kasei Corporation), XPY307, EPPN-201, EPPN-501, EPPN-502, EOCN-1025, EOCN-1020, EOCN-104S, RE-306 and EBPS-200 (trade names) (Nippon Kayaku Co., Ltd.) A.E.R.ECN-235, A.E.R.ECN-299 and EPX-30 (trade names) (ADEKA Corporation), Celloxide 2021 (trade name) (Daicel Corporation), and TEPIC (trade name) (Nissan Chemical Industries, Ltd.).

The epoxy compounds may be used in one kind or in combination of two or more kinds.

### 1-4-2-1. Epoxy Curing Agent

When a curable composition of the invention contains the epoxy resin, the composition may further contain an epoxy curing agent in view of further improving a chemical resistance thereof. As the epoxy curing agent, an acid anhydride curing agent, a polyamine curing agent, a catalyst curing agent or the like is preferred.

Specific examples of the acid anhydride curing agents include maleic anhydride, tetrahydrophthalic anhydride, hexahydrophthalic anhydride, methylhexahydrophthalic anhydride, hexahydrotrimellitic anhydride, phthalic anhydride, trimellitic anhydride, and a styrene-maleic anhydride copolymer.

Specific examples of the polyamine curing agents include diethylenetriamine, triethylenetetramine, tetraethylenepentamine, dicyandiamide, polyamideamine (polyamide resin), a ketimine compound, isophoronediamine, m-xylenediamine, m-phenylenediamine, 1,3-bis(aminomethyl)cyclohexane, N-aminoethylpiperazine, 4,4′-diaminodiphenylmethane, 4,4′-diamino-3,3′-diethyldiphenylmethane and diaminodiphenylsulfone.

Specific examples of the catalyst curing agents include a tertiary amine compound and an imidazole compound.

The epoxy curing agents may be used in one kind or in combination of two or more kinds.

### 1-4-3. Aldehyde Compound

Specific examples of the aldehyde compounds that can be used as the fourth component of the invention include formaldehyde, paraformaldehyde, trioxane, hexamethylenetetramine and glyoxal.

As the aldehyde compound that can be used as the fourth component of the invention, various kinds of commercial products can be used. Specific examples include GX (trade name) (the Nippon Synthetic Chemical Industry Co., Ltd.) and Sunrez 700M (trade name) (Omnova Solutions Inc.).

The aldehyde compounds may be used in one kind or in combination of two or more kinds.

### 1-4-4. Amine Compound

Specific examples of the amine compounds that can be used as the fourth component of the invention include hexamethylenediamine, m-xylylendiamine, 1,3-bisaminomethylcyclohexane and hexamethylenetetramine. Moreover, a salt may be formed using an arbitrary acid.

As the amine compound that can be used as the fourth component of the invention, various kinds of commercial products can be used. Specific examples include MXDA and 1,3-BAC (trade names) (Mitsubishi Gas Chemical Co., Inc.).

The amine compounds may be used in one kind or in combination of two or more kinds.

### 1-4-5. Methylol Compound

Specific examples of the methylol compounds that can be used as the fourth component of the invention include a novolak resin obtained by a condensation reaction between an aromatic compound having a phenolic hydroxyl group and aldehydes, a homopolymer of vinylphenol (including a hydrogenated compound), a vinylphenol copolymer between vinylphenol and a compound that can be copolymerized therewith (including a hydrogenated compound), a methylolurea resin, hexamethylolmelamine, hexamethoxymethylolmelamine, a methylolmelamine resin, an etherified methylolmelamine resin, a benzoguanamine resin, a methylolbenzoguanamine resin, an etherified methylolbenzoguanamine resin, and a condensate thereof. Among the compounds, a methylolmelamine resin and an etherified methylolmelamine resin both being a methylol compound are preferred in view of water solubility before crosslinking, and a good suitability for process and Environmental reliability after film formation. Furthermore, an etherified methylolmelamine resin being a protected methylol compound is further preferred in view of a good storage stability of the composition.

As the methylol compound that can be used as the fourth component of the invention, various kinds of commercial products can be used. Specific examples include TD-4304, PE-201L and PE-602L (trade names) (DIC Corporation), Shonol BRL-103, BRL-113, BRP-408A, BRP-520, BRL-1583 and BRE-174 (trade names) (Showa Denko K.K.), Riken Resin RG-80, Riken Resin RG-10, Riken Resin RG-1, Riken Resin RG-1H, Riken Resin RG-85, Riken Resin RG-83, Riken Resin RG-17, Riken Resin RG-115E, Riken Resin RG-260, Riken Resin RG-20E, Riken Resin RS-5S, Riken Resin RS-30, Riken Resin RS-150, Riken Resin RS-22, Riken Resin RS-250, Riken Resin RS-296, Riken Resin HM-272, Riken Resin HM-325, Riken Resin HM-25, Riken Resin MA-156, Riken Resin MA-100, Riken Resin MA-31, Riken Resin MM-3C, Riken Resin MM-3, Riken Resin MM-52, Riken Resin MM-35, Riken Resin MM-601, Riken Resin MM-630, Riken Resin MS and Riken Resin MM-65S (trade names) (MIKIRIKEN INDUSTRIAL CO., LTD), Bechamine NS-11, Bechamine LF-K, Bechamine LF-R, Bechamine LF-55P concentrated, Bechamine NS-19, Bechamine FM-28, Bechamine FM-7, Bechamine NS-200, Bechamine NS-210L, Bechamine FM-180, Bechamine NF-3, Bechamine NF-12, Bechamine NF-500K, Bechamine E, Bechamine N-13, Bechamine N-80, Bechamine J-300S, Bechamine N, Bechamine APM, Bechamine MA-K, Bechamine MA-S, Bechamine J-101, Bechamine J-101LF, Bechamine M-3, Bechamine M-3 (60), Bechamine A-1, Bechamine R-25H, Bechamine V-60 and Bechamine 160 (trade names) (DIC Corporation), Nikaresin S-176 and Nikaresin 260 (trade names) (Nippon Carbide Industries Co., Inc.), and Nikalac MW-30M, Nikalac MW-30, Nikalac MW-22, Nikalac MX-730, Nikalac MX-706, Nikalac MX-035, Nikalac MX-45 and Nikalac BX-4000 (trade names) (Sanwa Chemical Co., Ltd.).

The methylol compounds may be used in one kind or in combination of two or more kinds.

### 1-4-5-1. Catalyst and Reaction Initiator

When the coating forming composition of the invention contains the methylol compound, the coating forming composition may contain a catalyst or a reaction initiator in order to further improve curing properties. Specific examples of such catalysts include organic acids such as an aromatic sulfonic acid compound or a phosphoric acid compound, and a salt thereof, an amine compound and salts of the amine compound, an imine compound, an amidine compound, a guanidine compound, a heterocyclic compound containing a nitrogen atom, an organometallic compound, and metal salts such as zinc stearate, zinc myristate, aluminum stearate and calcium stearate. Specific examples of the reaction initiators include a photoacid generator and a photobase generator.

The catalysts and the reaction initiators may be used in one kind or in combination of two or more kinds. Moreover, a catalyst and a reaction initiator based on a different mechanism may also be used.

From a viewpoint of reactivity, a good dispersibility of each component in the composition, and a high conductivity, a good Optical transmission, a good Environmental reliability, a good suitability for process and a good adhesion of the coating obtained from the composition of the invention, content of the catalyst and the reaction initiator in the coating forming composition of the invention is preferably in the range of approximately 0.1 part by weight to approximately 100 parts by weight, further preferably, in the range of approximately 1 part by weight to approximately 50 parts by weight, still further preferably, in the range of approximately 5 parts by weight to approximately 25 parts by weight, based on 100 parts by weight of the methylol compound.

As the catalyst and the reaction initiator, various kinds of commercial products can be used. Specific examples include Riken Fixer RC, Riken Fixer RC-3, Riken Fixer RC-12, Riken Fixer RCS, Riken Fixer RC-W, Riken Fixer MX, Riken Fixer MX-2, Riken Fixer MX-18, Riken Fixer MX-18N, Riken Fixer MX-36, Riken Fixer MX-15, Riken Fixer MX-25, Riken Fixer MX-27N, Riken Fixer MX-051, Riken Fixer MX-7, Riken Fixer DMX-5, Riken Fixer LTC-66, Riken Fixer RZ-5, Riken Fixer XT-329, Riken Fixer XT-318, Riken Fixer XT-53, Riken Fixer XT-58 and Riken Fixer XT-45 (trade names) (MIKIRIKEN INDUSTRIAL CO., LTD.), Catalyst 376, Catalyst ACX, Catalyst O, Catalyst M, Catalyst X-80, Catalyst G, Catalyst X-60, Catalyst GT, Catalyst X-110, Catalyst GT-3, Catalyst NFC-1 and Catalyst ML (trade names) (DIC Corporation), and NACURE 155, NACURE 1051, NACURE 5076, NACURE 4054J, NACURE 2500, NACURE 5225, NACURE X49-110, NACURE 3525 and NACURE 4167 (trade names) (KING INDUSTRIES, INC).

### 1-5. Solvent

The coating forming composition of the invention is uniformly dispersed or uniformly dissolved into an arbitrary solvent. Specific examples of the arbitrary solvents include water, methanol, ethanol, isopropyl alcohol, 1-butanol, 2-butanol, 2-methyl-1-propanol, tert-butyl alcohol, pentyl alcohol, 1-methoxy-2-propanol, ethylene glycol, 1,2-propanediol, 1,3-propanediol and glycerol. However, the arbitrary solvent is not limited thereto. Moreover, the solvents may be used alone or may be mixed and used.

The solvent used in the coating forming composition of the invention preferably has a boiling point in the range of approximately 40° C. to approximately 300° C., further preferably, in the range of approximately 50° C. to approximately 250° C., still further preferably, in the range of approximately 60° C. to approximately 200° C.

### 1-6. Arbitrary Component

The coating forming composition of the invention may contain an arbitrary component in the range in which properties of the composition are not adversely affected. Specific examples of the arbitrary components include a binder component other than the second component, a corrosion inhibitor, a adhesion accelerator, a surfactant and a viscosity modifier.

1-6-1. Binder Component Other than the Second Component

As the binder component, various polymer compounds other than the second component and a gelling agent can also be used.

Specific examples of the various polymer compounds used as the binder component include a biopolymer compound such as protein, gelatin and polyamino acid, a polyacryloyl compound such as polymethyl methacrylate, polyacrylate and polyacrylonitrile, polyester such as polyethylene terephthalate, polyester naphthalate and polycarbonate, polystyrene, polyvinyl toluene, polyvinyl xylene, polyimide, polyamideimide, polyetherimide, polysulfide, polysulfone, polyphenylene, polyphenyl ether, polyurethane, epoxy(meth)acrylate, melamine(meth)acrylate, a polyolefin such as polypropylene, polymethylpentane and a cyclic olefin polymer, an acrylonitrile-butadiene-styrene copolymer (ABS), a silicone resin, polyvinyl chloride, chlorinated polyethylene, chlorinated polypropylene, polyacetate, polynorbornene, a synthetic rubber, a fluorinated polymer such as polyfluorovinylidene, polytetrafluoroethylene and polyhexafluoropropylene, a fluoroolefin-hydrocarbon olefin copolymer and a fluorocarbon polymer. However, the binder component is not limited thereto.

Specific examples of the gelling agents used as the binder component include metal soap, 12-hydroxystearic acid, dibenzylidenesorbitol, amide of N-acylamino acid, N-acylamino acid ester, and an N-acylamino acid amine salt. However, the gelling agent is not limited thereto.

### 1-6-2. Corrosion Inhibitor

As the corrosion inhibitor, a specific nitrogen-containing organic compound and a specific sulfur-containing organic compound such as aromatic triazole, imidazole, triazole and thiol, a biomolecule showing a specific affinity with a metal surface, and a compound for blocking a corrosive element by competing with a metal and so forth are known. Moreover, metal nanowires may be protected based on a different mechanism by a different corrosion inhibitor.

Specific examples of the corrosion inhibitors include alkyl-substituted benzotriazole such as tolyltriazole and butylbenzyltriazole, 2-aminopyrimidine, 5,6-dimethylbenzoimidazole, 2-amino-5-mercapto-1,3,4-thiadiazole, 2-mercaptopyrimidine, 2-mercaptobenzooxazole, 2-mercaptobenzothiazole, 2-mercaptobenzimidazole, cysteine, dithiothiadiazole, saturated C6 to C24 straight-chain alkyldithiothiadiazole, saturated C6 to C24 straight-chain alkylthiol, triazine and n-chlorosuccinimide. However, the corrosion inhibitor is not limited thereto. Moreover, the corrosion inhibitors may be used in one kind or in combination of two or more kinds.

### 1-6-3. Adhesion Promoter

As the adhesion accelerator, a compound that forms a bond between the substrate and the component in the composition, a compound that has a functional group showing affinity with the substrate and the component in the composition, and so forth are known. Moreover, the adhesion may be promoted based on a different mechanism by a different adhesion promoter.

Specific examples of the adhesion accelerators include a silane coupling agent such as 3-(3-aminopropyl)triethoxysilane, 3-(3-mercaptopropyl)trimethoxysilane and 3-methacryloyloxypropyltrimethoxysilane. However, the adhesion accelerator is not limited thereto. Moreover, the adhesion accelerators may be used in one kind or in combination of two or more kinds.

### 1-6-4. Surfactant

The coating forming composition of the invention may contain the surfactant for improving wettability to a base substrate or uniformity on a surface of a cured film obtained, for example. The surfactants are classified into an ionic surfactant and a nonionic surfactant according to a structure of a hydrophilic group, and further classified into an alkyl surfactant, a silicone surfactant and a fluorine surfactant according to a structure of a hydrophobic group. Moreover, the surfactants are classified according to a molecular structure into a surfactant that has a comparatively small molecular weight and a simple structure, and a macromolecular surfactant that has a large molecular weight and has a side chain or a branch. The surfactants are classified according to a composition into a single surfactant, and a mixed surfactant in which two or more kinds of surfactants and a base material are mixed. As the surfactant to be added to the coating forming composition of the invention, all kinds of surfactants can be used.

Specific examples of commercial products of the surfactants include Zonyl FSO-100, Zonyl FSN, Zonyl FSO and Zonyl FSH (trade names) (E. I. du Pont de Nemours & Co.), Triton X-100, Triton X-114 and Triton X-45 (trade names) (Sigma-Aldrich Japan, Inc.), Dynol 604 and Dynol 607 (trade names) (Air products Japan, Inc.), n-Dodecyl-β-D-maltoside, Novek, Byk-300, Byk-306, Byk-335, Byk-310, Byk-341, Byk-344, Byk-370, Byk-354, Byk-358 and Byk-361 (trade names) (BYK Japan, KK), DFX-18, Ftergent 250 and Ftergent 251 (trade names) (Neos Co., Ltd.), and Megafac F-479 and Megafac F-472SF (trade names) (DIC Corporation). However, the surfactant is not limited thereto. Moreover, the surfactants may be used in one kind or in combination of two or more kinds.

### 1-6-5. Viscosity Modifier

The coating forming composition of the invention may contain the viscosity modifier for improving wettability to the base substrate or uniformity of the surface on the cured film obtained, for example. Specific examples of the viscosity modifiers include a polyether, urethane-modified polyether, modified polyacrylic acid or modified polyacrylate compound. However, the viscosity modifier is not limited thereto. Moreover, the viscosity modifiers may be used alone or may be mixed and used.

### Composition and Physical Properties of the Coating Forming Composition

The coating forming composition of the invention is a composition in which the first component to the fourth component and the arbitrary component are uniformly dispersed or dissolved into the solvent.

With regard to content of each component in the coating forming composition of the invention, from a viewpoint of a good dispersibility of each component in the composition, and a high conductivity, a good luminous transmission, a good Environmental reliability, a good suitability for process and a good adhesion of the coating obtained from the composition of the invention, preferably, the content of the first component is in the range of approximately 0.01% by weight to approximately 1.0% by weight based on the total weight of the coating forming composition, the content of the second component is in the range of approximately 50 parts by weight to approximately 500 parts by weight based on 100 parts by weight of the first component, the content of the third component is in the range of approximately 1.0 part by weight to approximately 100 parts by weight based on 100 parts by weight of the second component, and the content of the fourth component is in the range of approximately 1.0 part by weight to approximately 100 parts by weight based on 100 parts by weight of the second component. Further preferably, the content of the first component is in the range of approximately 0.05% by weight to approximately 0.75% by weight based on the total weight of the coating forming composition, the content of the second component is in the range of approximately 100 parts by weight to approximately 500 parts by weight based on 100 parts by weight of the first component, the content of the third component is in the range of approximately 2.5 parts by weight to approximately 70 parts by weight based on 100 parts by weight of the second component, and the content of the fourth component is in the range of approximately 2.5 parts by weight to approximately 50 parts by weight based on 100 parts by weight of the second component. Still further preferably, the content of the first component is in the range of approximately 0.1% by weight to approximately 0.5% by weight based on the total weight of the coating forming composition, the content of the second component is in the range of approximately 200 parts by weight to approximately 300 parts by weight based on 100 parts by weight of the first component, the content of the third component is in the range of approximately 5 parts by weight to approximately 40 parts by weight based on 100 parts by weight of the second component, and the content of the fourth component is in the range of approximately 5.0 parts by weight to approximately 25 parts by weight based on 100 parts by weight of the second component.

More specifically, with regard to the composition of each component based on the total weight of the composition, preferably, the content of the first component is in the range of approximately 0.01% by weight to approximately 1.0% by weight, the content of the second component is in the range of approximately 0.0050% by weight to approximately 5.0% by weight, the content of the third component is in the range of approximately 0.000050% by weight to approximately 5.0% by weight, and the content of the fourth component is in the range of approximately 0.000050% by weight to approximately 5.0% by weight for the fourth component, further preferably, the content of the first component is in the range of approximately 0.050% by weight to approximately 0.750% by weight, the content of the second component is in the range of approximately 0.050% by weight to approximately 3.0% by weight, the content of the third component is in the range of approximately 0.001250% by weight to approximately 0.5250% by weight, and the content of the fourth component is in the range of approximately 0.001281250% by weight to approximately 1.76250% by weight, still further preferably, the content of the first component is in the range of approximately 0.10% by weight to approximately 0.50% by weight, the content of the second component is in the range of approximately 0.20% by weight to approximately 1.50% by weight, the content of the third component is in the range of approximately 0.0050% by weight to approximately 0.20% by weight, and the content of the fourth component is in the range of approximately 0.010250% by weight to approximately 0.4250% by weight.

The coating forming composition of the invention can be manufactured by appropriately selecting agitating, mixing, heating, cooling, dissolving, dispersing or the like of the components as described above according to a publicly known method.

As the viscosity of the coating forming composition of the invention is higher, a more uniform dispersibility is obtained for a long period of time because precipitation of the metal nanowires and the metal nanotubes is suppressed. Moreover, as the viscosity is higher, a film having a higher conductivity can be obtained because film thickness can be increased under fixed application conditions. On the other hand, as the viscosity is lower, roughness and uniformity of the coating is better. Thus, the viscosity (at 25° C.) of the coating forming composition of the invention is preferably in the range of approximately 1 mPa·s to approximately 100 mPa·s, further preferably, in the range of approximately 10 mPa·s to approximately 70 mPa·s. In the invention, the viscosity is expressed by means of a value measured by using a cone plate type rotational viscometer.

### Method for Manufacturing a Substrate Having a Transparent Conductive Film

The substrate having the transparent conductive film can be manufactured by using the coating forming composition of the invention. The method for manufacturing the substrate includes a process for forming the coating on the substrate by applying the composition onto the substrate, and then heating the substrate at a temperature in the range of approximately 40° C. to approximately 240° C. Heating may be performed only once, or twice or more at different temperatures.

The coating having the conductivity, the Environmental reliability and the suitability for process is formed on the substrate by applying the composition onto the substrate, and then removing the solvent.

The substrate may be hard or flexible. Moreover, the substrate may be colored. Specific examples of materials of the substrate include glass, polyimide, polycarbonate, polyethersulfone, acryloyl, polyester, polyethylene terephthalate, polyethylene naphthalate, polyolefin, polyvinyl chloride, and a material formed after impregnating the resin described above into glass fibers or the like. The materials preferably have a high Optical transmittance and a low haze value. Furthermore, a circuit such as a TFT element may be preferably formed on the substrate, or an organic functional material such as a color filter and an overcoat, or an inorganic functional material such as a silicon nitride or silicon oxide film may be formed thereon. Moreover, a large number of the substrates may be laminated on the substrate.

As the method for applying the composition of the invention onto the substrate, a general method can be applied, such as a spin coating method, a slit coating method, a dip coating method, a blade coating method, a spray method, a screen printing method, a relief printing method, an intaglio printing method, a planographic printing method, a dispensing method and an ink jet method. From a viewpoint of the uniformity of the film thickness and productivity, the spin coating method and the slit coating method are preferred, and the slit coating method is further preferred.

The surface resistance is determined depending on an application.

The surface resistance is determined depending on the film thickness and surface density of the first component. The film thickness and the surface density of the first component are determined depending on viscosity and a concentration of the first component in the coating forming composition. The film thickness is determined depending on application conditions. Accordingly, a desired surface resistance is controlled by the viscosity and the concentration of the first component in the coating forming composition.

A larger film thickness is better from a viewpoint of a low surface resistance, and a smaller film thickness is better from a viewpoint of suppressing occurrence of a poor display due to a profile. When comprehensively taking the facts into consideration, the film thickness is preferably in the range of approximately 1 nanometer to approximately 500 nanometers, further preferably, in the range of approximately 5 nanometers to approximately 250 nanometers, still further preferably, in the range of approximately 10 nanometers to approximately 150 nanometers.

The solvent is removed by performing heating treatment of an applied article when necessary. As heating temperature, heating is ordinarily performed at a temperature in the range of approximately 30° C. to approximately a boiling point of the solvent plus 50° C., although the range is different depending on kinds of solvents.

The surface resistance and the total transmittance of the film obtained can be adjusted to a desired value by adjusting the film thickness or an applied amount of the composition, conditions of the application method, and the concentration of the first component in the coating forming composition of the invention.

In general, as the film thickness is larger, the surface resistance and the total transmittance are further decreased. Moreover, as the concentration of the first component in the coating forming composition is higher, the surface resistance and the total transmittance are further decreased.

The coating obtained as described above has preferably a surface resistance in the range of approximately 1Ω/□ to approximately 10,000 Ω/□ and a total transmittance in the range of approximately 80% or more, further preferably, a surface resistance in the range of approximately 10Ω/□ to approximately 5,000Ω/□ and a total transmittance in the range of approximately 85% or more.

In the invention, unless otherwise noted, the surface resistance is expressed in terms of a measured value according to a non-contact measurement method as described later.

### Patterning of a Transparent Conductive Film

Patterning of the transparent conductive film prepared according to the invention can be performed according to the application. As the method therefor, a photolithography using a resist material generally used for patterning of ITO can be applied. Procedures of the photolithography are shown below.

(Process 1) Resist application

### (Process 2) Bake

### (Process 3) Exposure

### (Process 4) Development

### (Process 5) Etching

### (Process 6) Strip

### Arbitrary Process

Before and after each process of film formation and patterning of the composition described above, a suitable treatment process, a suitable cleaning process and a suitable drying process may be appropriately applied. Specific examples of the treatment processes include plasma surface treatment, ultrasonic treatment, ozone treatment, cleaning treatment using a suitable solvent and heating treatment. Moreover, a process for immersion into water may be applied. Such immersion into water is preferred from a viewpoint of a low surface resistance.

The plasma surface treatment can be applied for improving applicability of the coating forming composition or a developer. For example, the surface of the substrate or the coating forming composition on the substrate can be treated under conditions of 100 W, 90 seconds, an oxygen flow rate of 50 sccm (sccm; standard cc/min), a temperature of 0° C. and a pressure of 50 Pa by using oxygen plasma. According to the ultrasonic treatment, particulates physically deposited or the like on the substrate can be removed by immersing the substrate into a solution, and propagating ultrasonic waves having a frequency of approximately 200 kHz, for example. According to the ozone treatment, a deposit or the like on the substrate can be effectively removed by blowing air onto the substrate and simultaneously irradiating the substrate with ultraviolet light and utilizing oxidizing power of ozone generated by the ultraviolet light. According to the cleaning treatment, a particulate impurity can be washed out and removed by spraying pure water in a mist form or a shower form and utilizing dissolving capability and pressure of the pure water, for example. The heating treatment is a method for removing a compound to be desirably removed in the substrate by volatilizing the compound. Heating temperature is appropriately set up in consideration of a boiling point of the compound to be desirably removed. For example, when the compound to be desirably removed is water, the substrate is heated at a temperature in the range of approximately 50° C. to approximately 150° C.

As for the surface resistance and the total transmittance of the transparent conductive film on the substrate having a transparent conductive film subjected to patterning as obtained according to the manufacturing method as described above, the transparent conductive film has preferably a surface resistance in the range of approximately 1Ω/□ to approximately 10,000Ω/□ and a total transmittance in the range of approximately 80% or more, further preferably, a surface resistance in the range of approximately 10Ω/□ to approximately 5,000Ω/□ and a total transmittance in the range of approximately 85% or more.

Herein, “total transmittance” is a ratio of transmitted light to incident light, and the transmitted light includes a directly transmitted component and a scattered component. A light source is illuminant C and a spectrum is a CIE luminosity function y. Moreover, the film thickness is preferably in the range of approximately 1 nanometer to approximately 500 nanometers, further preferably, in the range of approximately 5 nanometers to approximately 250 nanometers, still further preferably, in the range of approximately 10 nanometers to approximately 150 nanometers, although the film thickness is different according to the application.

Such surface resistance and total transmittance can be adjusted to a desired value by adjusting the film thickness or the applied amount of the composition, and conditions of the application method, and the concentration of the first component in the coating forming composition of the invention.

As for the transparent conductive film subjected to patterning, an insulating film, an overcoat having a protective function or a polyimide layer having an alignment function can be further arranged on the surface thereof.

### Application of the Substrate Having the Transparent Conductive Film Subjected to Patterning

The substrate having the transparent conductive film subjected to patterning is used for a device element because of conductivity and optical properties thereof.

Specific examples of the device elements include a liquid crystal display element, an organic electroluminescence element, an electronic paper, a touch panel element and a photovoltaic cell element.

The device element may be prepared by using a rigid substrate or a flexible substrate or a combination thereof. Moreover, the substrate used for the device element may be transparent or colored.

Specific examples of the transparent conductive films used for the liquid crystal display element include a pixel electrode to be formed on a side of a thin film transistor (TFT) array substrate and a common electrode formed on a side of a color filter substrate. Specific examples of display modes of LCD include Twisted Nematic (TN), Multi Vertical Alignment (MVA), Patterned Vertical Alignment (PVA), In-Plane Switching (IPS), Fringe Field Switching (FFS), Polymer Stabilized Vertical Alignment (PSA), Optically Compensated Bend (OCB), Continuous Pinwheel Alignment (CPA) and Blue Phase (BP). Moreover, a transmissive type, a reflective type and a transflective type are provided for each of the modes. The pixel electrode of LCD is subjected to patterning for each pixel, and is electrically connected to a drain electrode of TFT. In addition thereto, the IPS mode has a comb electrode structure, and the PVA mode has a structure in which slits are curved in the pixel, for example.

The transparent conductive film used for the organic electroluminescence element is ordinarily subjected to patterning in a stripe on the substrate, when the film is used as a conductive region of a passive type driving mode. A direct current voltage is applied between the conductive region in the stripe (anode) and a conductive region in a stripe arranged orthogonally thereto (cathode), and thus display is conducted by allowing pixels in a matrix to emit light. When the film is used as an electrode of an active type driving mode, the film is subjected to patterning on the side of the TFT array substrate for each pixel.

The touch panel element includes a resistive type and a capacitive type depending on a detection method of touch, and a transparent electrode is used for any of the types. The transparent electrode used for the capacitive type is subjected to patterning.

The electronic paper includes a microcapsule type, a quick response liquid powder type, a liquid crystal type, an electrowetting type, an electrophoretic type and a chemical reaction change type depending on a display method of a matter, and the transparent electrode is used for any of the types. The transparent electrode is subjected to patterning in an arbitrary shape, respectively.

The photovoltaic cell element includes a silicon type, a compound type, an organic type and a quantum dot type depending on a material of an optical absorption layer, and the transparent electrode is used for any of the types. The transparent electrode is subjected to patterning in an arbitrary shape, respectively.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

In the following, the invention will be further specifically explained by way of Examples, but the invention is not limited to the Examples. In Examples and Comparative Examples, ultrapure water was used as water being a constituent. However, the ultrapure water may be occasionally referred to simply as water in the following. The ultrapure water was prepared using Puric FPC-0500-0M0 (trade name) (Organo Corporation).

Measurement methods or evaluation methods in each evaluation item were applied according to methods as described below.

Unless otherwise noted, measurements (1) to (4) were carried out in a region in which a transparent conductive film of a sample to be evaluated was formed.

### (1) Measurement of Surface Resistance

As the evaluation method, two kinds of a four-point probe method and a non-contact measurement method were applied.

Loresta-GP MCP-T610 (Mitsubishi Chemical Corporation) was used for the four-point probe measurement method (in accordance with JIS K7194). A probe used for measurement is a proprietary ESP type probe having a distance of 5 millimeters between pins, and a pin point diameter of 2 millimeters. Surface resistance (Ω/□) was calculated by bringing the probe into contact with the sample to be evaluated, measuring a potential difference between two inner terminals when applying a fixed current to two outer terminals, and multiplying resistance obtained by the measurement by a correction coefficient. Volume resistivity (Ω·cm) and conductivity (Siemens/cm) can be determined from the thus obtained surface resistance value and thickness of a conductive film.

According to the four-point probe measurement method, surface resistance of the conductive film on the substrate in which at least one insulating film was formed on the conductive film, and surface resistance of the conductive film in which metal nanowires or metal nanotubes as shown herein were dispersed into an insulator cannot be stably measured sometimes. In the case, a non-contact surface resistance measurement method using an eddy current was applied. As the non-contact measurement method, surface resistance (Ω/□) was measured using 717 B-H (DELCOM). Also in the case, volume resistivity (Ω·cm) and conductivity (Siemens/cm) can be determined from the thus obtained surface resistance value and thickness of the conductive film. In addition, a measured value according to the four-point probe method and a measured value according to the non-contact measurement method agree substantially. Unless otherwise noted herein, the non-contact measurement method was applied.

### (2) Measurement of Total Transmittance and Haze

Haze-Gard Plus (BYK Gardner, Inc.) was used for measurement of total transmittance and haze. Air was used as a reference.

### (3) Film Thickness

Profilometer P-16+ (KLA-Tencor) was used for measurement of film thickness.

The film thickness was measured in accordance with “Test method for thickness of fine ceramic thin films—Film thickness by contact probe profilometer” (JIS R1636). When measuring film thickness of a film not subjected to patterning, part of a film of a sample to be evaluated was shaved off, and a profile on a boundary surface was measured.

### (4) Environmental Reliability Test

Environmental reliability was evaluated by allowing a transparent conductive film to stand in a high temperature and high humidity oven at 70° C. and 90% RH, measuring surface resistance, total transmittance and haze after 500 hours, and comparing measured values with initial values.

Evaluation results were provided based on a ratio of change of the surface resistance, the total transmittance and the haze in comparison with the initial values, respectively. A sample was rated to be good when a ratio of change of all of the characteristics was in the range of 0% to 50%, marginal when a ratio of change of at least one of the characteristics was in the range of 51% to 100%, and bad when a ratio of change of at least one of the characteristics was in the range of 101% or more.

### (5) Testing of Suitability for Process

Water was sprayed onto a sample to be evaluated under conditions of a water temperature of 23° C., a water pressure of 270 kPa and a treatment time of 1 or 5 minutes by using Developer EX-25D (Yoshitani Shoji K. K.). Suitability for process was evaluated by performing (a) visual inspection of presence or absence of film peeling, (b) measurement of surface resistance, and (c) measurement of total transmittance and haze before and after spraying.

The film was visually observed, and evaluation results were provided. A sample was rated to be good when no peeling of the film was observed under conditions of a water temperature of 23° C., a water pressure of 270 kPa and a treatment time of 1 minute, marginal when peeling was observed in an area of 1% to 50% of the substrate, and bad when peeling was observed in an area of 51% to 100% of the substrate. A sample rated to be good was further evaluated under conditions of a water temperature of 23° C., a water pressure of 270 kPa and a treatment time of 5 minutes, and a sample was rated to be excellent when no peeling of the film was observed.

### (6) Measurement of Viscosity of a Composition

As for a viscosity of a composition used in Examples, viscosity when temperature was 25° C. and a shear rate was 100 s⁻¹ was measured using TV-22 Viscometer (Toki Sangyo Co., Ltd.).

### (7) Testing of Dispersion Stability of a Composition (Dispersibility)

After putting 10 g of composition used in Examples in a 20 mL screw vial and sufficiently shaking the vial up, the vial was allowed to stand for one week under room temperature. Precipitation of silver nanowires after allowing the vial to stand was visually confirmed. A composition in which no precipitation of silver nanowires was observed was rated to be good, and a composition in which precipitation of silver nanowires was observed on the bottom of the screw vial was rated to be bad.

### (8) Adhesion Test

A cross cut test was performed using 3M396 tape and 3M810 tape (trade names) (Sumitomo 3M Co., Ltd.), and the number of residues after tape peeling in 100 cross cuts having a size of 1 mm×1 mm was evaluated. A sample in which no peeling was observed was rated to be good, a sample in which peeling of 1 to 100 cuts was observed was rated to be bad.

### (9) Testing of Hardness

In measurement of hardness, testing was conducted using each type of pencils from 6B to 2H by using a tester in accordance with “Pencil scratch tester for a paint film (JIS K5401).” A film surface of an evaluation sample after testing was visually observed, and whether or not a coating was broken was evaluated.

In the evaluation, when the hardest pencil without causing break of the coating was 2H or higher, a sample was rated to be “satisfactory (excellent),” when such a pencil was lower than 2H and 6B or higher was rated to be “somewhat poor (marginal),” and when flaking was caused with all pencils, a sample was rated to be “poor (bad).”

The first component (metal nanowires or metal nanotubes) used in the invention was prepared as described below.

### Synthesis of Silver Nanowires

A reaction mixture containing silver nanowires was obtained by putting 4.171 g of poly(N-vinylpyrrolidone) (trade name; Polyvinylpyrrolidone K30, MW 40,000, Tokyo Kasei Kogyo Co., Ltd.), 70 mg of tetrabutylammonium chloride (trade name; Tetrabutylammonium chloride, Wako Pure Chemical Industries, Ltd.), 4.254 g of silver nitrate (trade name; Silver nitrate, Wako Pure Chemical Industries, Ltd.) and 500 mL of ethylene glycol (trade name; Ethylene glycol, Wako Pure Chemical Industries, Ltd.) in a 1,000 mL flask, agitating the mixture for 15 minutes and uniformly dissolving the mixture, and agitating the mixture at 110° C. for 16 hours in an oil bath.

Subsequently, the reaction mixture was returned to room temperature (25 to 30° C.), and then a reaction solvent was replaced by water with a centrifuge (As One Corporation), and thus aqueous silver nanowire dispersion solution I having an arbitrary concentration was obtained. According to the operation, unreacted silver nitrate, poly(N-vinylpyrrolidone) and tetrabuthylammonium chloride used for controlling their morphology, ethylene glycol and silver nanoparticles having a small particle size in the reaction mixture were removed. Mean values of length of the silver nanowires in a minor axis, and length thereof in a major axis, and an aspect ratio were 42 nanometers, 18 micrometers and 429, respectively.

### Example 1

### (Composition Containing Hydroxypropyl Methyl Cellulose (Second Component) and (Ammonium Lactato)Titanium Neutralized Product (Third Component))

### Preparation of Polymer Solution I (Second Component)

In a 300 mL beaker whose tare weight was premeasured, 100 g of ultrapure water was put, and heated and agitated. At a liquid temperature of 80 to 90° C., 2.00 g of hydroxypropyl methyl cellulose (abbreviated as HPMC, trade name; Metolose 90SH-100000, Shin-Etsu Chemical Co., Ltd.) was put in the beaker little by little, and the resultant mixture was strongly agitated to uniformly disperse HPMC. While keeping strong agitation, 80 g of ultrapure water was added, and simultaneously heating was stopped, and agitation was continued while cooling the beaker with ice water until a uniform solution was formed. After agitation for 20 minutes, ultrapure water was added for weight of an aqueous solution to be 200.00 g, and agitation was continued for further 10 minutes at room temperature until a uniform solution was formed, and thus 1 wt. % aqueous polymer solution I was prepared.

### Preparation of Base Solution I (Containing Second Component)

A silver nanowires dispersion aqueous solution and 1.0 wt. % polymer solution I were mixed, and base solution I containing 0.25 wt. % silver nanowire and 0.5 wt. % HPMC was prepared using ultrapure water.

### Preparation of Crosslinking Agent Solution I (Third Component)

First, 0.19 g of Orgatix TC-300 (trade name) ((ammonium lactato)titanium neutralized product, Matsumoto Fine chemical Co., Ltd.) having 42 wt. % solid concentration was weighed, and then diluted with 7.81 g of ultrapure water to prepare 1.0 wt. % crosslinking agent solution I.

### Preparation of a Surfactant Solution

First, 0.08 g of Triton X-100 (trade name) (octylphenyl polyethylene glycol, Sigma-Aldrich Japan, Inc.) was weighed, and then diluted with 7.92 g of ultrapure water to prepare a 1.0 wt. % surfactant solution.

### Preparation of a Coating Forming Composition

First, 4.80 g of base solution I, 0.20 g of surfactant solution and 2.28 g of ultrapure water were weighed and agitated until a uniform solution was formed. Subsequently, 0.72 g of crosslinking agent solution I containing 1.0 wt. % solid was added, and the resultant mixture was agitated until a uniform solution was obtained, and thus a coating forming composition of a composition as described below was obtained. The prepared coating forming composition had a viscosity of 32.0 mPa·s, and showed a good dispersibility.

| | | |
|---|---|---|
| Silver nanowire | 0.15% | by weight |
| HPMC | 0.3% | by weight |
| Orgatix TC-300 | 0.090% | by weight |
| Triton X-100 | 0.025% | by weight |
| Water | 99.435% | by weight |

In addition, HPMC corresponded to 200 parts by weight based on 100 parts by weight of silver nanowires, and Orgatix TC-300 corresponded to 30 parts by weight based on 100 parts by weight of HPMC.

### Preparation of a Transparent Conductive Film

On a surface of a 0.7 mm-thick Eagle XG (trade name) (Corning, Inc.) glass substrate subjected to UV ozone treatment with an irradiation energy of 1,000 mJ/cm² (low-pressure mercury lamp (254 nanometers)), 1 mL of the coating forming composition obtained was added dropwise, and spin coating was performed at 300 rpm using a spin coater (trade name; MS-A150, Mikasa Inc.). Pre-bake was performed on the glass substrate on a hot stage at 50° C. under conditions for 90 seconds, and then post-bake was performed for 10 minutes on the hot stage at 140° C., and thus a transparent conductive film was prepared.

### Evaluation of the Transparent Conductive Film

The transparent conductive film obtained had a surface resistance value of 26.0Ω/□, a total transmittance of 90.1%, a haze of 1.9% and a film thickness of 80.2 nanometers. Moreover, suitability for process and hardness were good.

The evaluation results were shown in Table 1. In addition, only an evaluation using a glass substrate was summarized in the table.

### Example 2

### (Composition Containing Polyvinyl Alcohol (Second Component, a Polymer Compound Having Hydroxyl Group) and (Ammonium Lactato)Titanium Neutralized Product (Third Component))

### Preparation of Polymer Solution II (Second Component)

In a 300 mL beaker whose tare weight was premeasured, 20 g of ultrapure water was put, and heated and agitated. At a liquid temperature of 80 to 90° C., 0.50 g of polyvinyl alcohol (abbreviated as PVA 500CH, degree of polymerization 500, completely saponified. Trade name; Polyvinyl Alcohol 500, completely saponified, Wako Pure Chemical Industries, Ltd.) was put in the beaker little by little, and strongly agitated to uniformly disperse PVA 500CH. Agitation was continued while keeping the liquid temperature at 80 to 90° C. until a uniform solution was formed. After agitation for 20 minutes, ultrapure water was added for weight of an aqueous solution to be 50.00 g, and agitation was continued for further 10 minutes at room temperature until a uniform solution was formed, and thus 1.0 wt. % aqueous polymer solution II was prepared.

### Preparation of Base Solution II (Containing Second Component)

Base solution II containing 0.25 wt. % silver nanowires and 0.5 wt. % PVA was prepared by mixing a silver nanowires dispersion aqueous solution and 1.0 wt. % polymer aqueous solution II.

### Preparation of a Coating Forming Composition

Then, 4.80 g of base solution II, 0.20 g of a surfactant solution and 2.28 g of ultrapure water were weighed and agitated until a uniform solution was formed. Subsequently, 0.72 g of crosslinking agent solution I containing 1.0 wt. % solid was added and the resultant mixture was agitated until a uniform solution was formed, and thus a coating forming composition having a composition as described below was obtained. The prepared coating forming composition had a viscosity of 28.1 mPa·s, and showed a good dispersibility.

| | | |
|---|---|---|
| Silver nanowire | 0.15% | by weight |
| PVA 500CH | 0.3% | by weight |
| Orgatix TC-300 | 0.090% | by weight |
| Triton X-100 | 0.025% | by weight |
| Water | 99.435% | by weight |

In addition, PVA corresponded to 200 parts by weight based on 100 parts by weight of silver nanowires and corresponded to 30 parts by weight based on 100 parts by weight of PVA.

A transparent conductive film was prepared according to procedures similar to Example 1. The transparent conductive film obtained had a surface resistance value of 45.6Ω/□, a total transmittance of 90.2%, a haze of 2.1% and a film thickness of 78.4 nanometers. Moreover, suitability for process and hardness were good.

### Example 3

### (Composition Containing Hydroxypropyl Methyl Cellulose and Polyvinyl Alcohol (Second Component) and (Ammonium Lactato) Titanium Neutralized Product (Third Component))

### Preparation of a Coating Forming Composition

Then 4.80 g of base solution I, 0.20 g of a surfactant solution, 0.72 g of ultrapure water and 1.20 g of polymer solution II were weighed and agitated until a uniform solution was formed. Subsequently, 1.08 g of crosslinking agent solution I containing 1.0 wt. % solid was added and the resultant mixture was agitated until a uniform solution was formed, and thus a coating forming composition having the following composition was obtained. The prepared coating forming composition had a viscosity of 32.0 mPa·s, and showed a good dispersibility.

| | | |
|---|---|---|
| Silver nanowire | 0.15% | by weight |
| HPMC | 0.3% | by weight |
| PVA 500CH | 0.15% | by weight |
| Orgatix TC-300 | 0.135% | by weight |
| Triton X-100 | 0.025% | by weight |
| Water | 99.24% | by weight |

In addition, the total weight of HPMC and PVA corresponded to 300 parts by weight based on 100 parts by weight of silver nanowires and total weight of Orgatix corresponded to 30 parts by weight based on 100 parts by weight of the total weight of HPMC and PVA.

A transparent conductive film was prepared according to procedures similar to Example 1. The transparent conductive film obtained had a surface resistance value of 24.8Ω/□, a total transmittance of 90.2%, a haze of 1.9% and a film thickness of 96.5 nanometers. Moreover, suitability for process and hardness were good.

### Example 4

### (Composition Containing Hydroxypropyl Methyl Cellulose and Polyvinyl Alcohol (Second Component), and (Ammonium Lactato) Titanium Neutralized Product (Third Component))

### Preparation of a Coating Forming Composition

First, 4.80 g of base solution I, 0.20 g of a surfactant solution, 0.72 g of ultrapure water and 1.20 g of polymer solution II were weighed and agitated until a uniform solution was obtained. Subsequently, 1.08 g of crosslinking solution I containing 1.0 wt. % solid was added and agitated until a uniform solution was formed, and thus a coating forming composition having the following composition was obtained. The prepared coating forming composition had a viscosity of 30.7 mPa·s, and showed a good dispersibility.

| | | |
|---|---|---|
| Silver nanowire | 0.15% | by weight |
| HPMC | 0.3% | by weight |
| PVA 500CH | 0.15% | by weight |
| Orgatix TC-300 | 0.0225% | by weight |
| Triton X-100 | 0.025% | by weight |
| Water | 99.3525% | by weight |

In addition, the total weight of HPMC and PVA corresponded to 300 parts by weight based on 100 parts by weight of silver nanowires and total weight of Orgatix corresponded to 30 parts by weight based on 100 parts by weight of the total weight of HPMC and PVA.

A transparent conductive film was prepared according to procedures similar to Example 1. The transparent conductive film obtained had a surface resistance value of 24.4Ω/□, a total transmittance of 90.4%, a haze of 1.9% and a film thickness of 94.3 nanometers. Moreover, suitability for process and hardness were good.

### Example 5

### (Composition Containing Hydroxypropyl Methyl Cellulose and Polyvinyl Alcohol (Second Component), (Ammonium Lactate) Titanium Neutralized Product (Third Component) and Hexamethoxymethylolmelamine (Fourth Component))

### Preparation of Second Crosslinking Agent Solution I (Fourth Component)

First, 0.11 g of Nikalac MW-22 (trade name) (hexamethoxymethylolmelamine, Sanwa Chemical Co., Ltd.) having 70 wt. % solid concentration was weighed, diluted with 7.89 g of isopropyl alcohol (IPA), and thus 1.0 wt. % second crosslinking agent solution I was prepared.

### Preparation of a Coating Forming Composition

First, 4.80 g of base solution I, 0.20 g of a surfactant solution, 0.36 g of ultrapure water and 1.20 g of polymer solution II were weighed and agitated until a uniform solution was obtained. Subsequently, 1.08 g of crosslinking agent solution I containing 1.0 wt. % solid and 0.36 g of second crosslinking agent solution I were added, and the resultant solution was agitated until a uniform solution was obtained, and thus a coating forming composition of a composition described below was obtained. The prepared coating forming composition had a viscosity of 31.5 mPa·s and showed good dispersibility.

| | | |
|---|---|---|
| Silver nanowire | 0.15% | by weight |
| HPMC | 0.3% | by weight |
| PVA 500 CH | 0.15% | by weight |
| Nikalac MW-22 | 0.045% | by weight |
| Orgatix TC-300 | 0.135% | by weight |
| Triton X-100 | 0.025% | by weight |
| IPA | 4.5% | by weight |
| Water | 94.695% | by weight |

In addition, the total weight of HPMC and PVA corresponded to 300 parts by weight based on 100 parts by weight of silver nanowires and Orgatix corresponded to 30 parts by weight based on 100 parts by weight of the total weight of HPMC and PVA, and Nikalac corresponded to 10 parts by weight based on 100 parts by weight of the total weight of HPMC and PVA.

A transparent conductive film was prepared according to procedures similar to Example 1. The transparent conductive film obtained had a surface resistance value of 26.6Ω/□, a total transmittance of 91.7%, a haze of 2.4% and a film thickness of 95 nanometers. Moreover, Environmental reliability, suitability for process, adhesion and hardness were good. Furthermore, Environmental reliability, suitability for process, adhesion and hardness were good also on silicon nitride and an overcoat (product name: PIG-7414, JNC Corporation).

### Example 6

(Composition Containing Hydroxypropyl Methyl Cellulose and Polyvinyl Alcohol (Second Component), (Ammonium Lactate)Titanium Neutralized Product (Third Component), and Hexamethoxymethylolmelamine (Fourth Component), an Amount of Adding the Third Component is Smaller than the Amount in EXAMPLE 5)

### Preparation of a Coating Forming Composition

First, 4.80 g of base solution I, 0.20 g of a surfactant solution, 1.08 g of ultrapure water and 1.20 g of polymer solution II were weighed and agitated until a uniform solution was obtained. Subsequently, 0.36 g of crosslinking agent solution I containing 1.0 wt. % solid and 0.36 g of second crosslinking agent solution I containing 1.0 wt. % solid were added, the resultant solution was agitated until a uniform solution was obtained, and thus a coating forming composition of a composition described below was obtained. The prepared coating forming composition had a viscosity of 31.4 mPa·s, and showed a good dispersibility.

| | | |
|---|---|---|
| Silver nanowire | 0.15% | by weight |
| HPMC | 0.3% | by weight |
| PVA 500CH | 0.15% | by weight |
| Nikalac MW-22 | 0.045% | by weight |
| Orgatix TC-300 | 0.045% | by weight |
| Triton X-100 | 0.025% | by weight |
| IPA | 4.5% | by weight |
| Water | 94.785% | by weight |

In addition, the total weight of HPMC and PVA corresponded to 300 parts by weight based on 100 parts by weight of silver nanowires, Orgatix corresponded to 10 parts by weight based on 100 parts by weight of the total weight of HPMC and PVA, and Nikalac corresponded to 10 parts by weight based on 100 parts by weight of the total weight of HPMC and PVA.

A transparent conductive film was prepared according to procedures similar to Example 1. The transparent conductive film obtained had a surface resistance value of 22.0Ω/□, a total transmittance of 91.4%, a haze of 2.2% and a film thickness of 98 nanometers. Moreover, Environmental reliability, suitability for process, adhesion and hardness were good. Furthermore, Environmental reliability, suitability for process, adhesion and hardness were good also on silicon nitride and an overcoat (product name: PIG-7414, JNC Corporation).

### Example 7

(Composition Containing Hydroxypropyl Methyl Cellulose and Polyvinyl Alcohol (Second Component), (Ammonium Lactate)Titanium Neutralized Product (Third Component), and Hexamethoxymethylolmelamine (Fourth Component), Polyvinyl Alcohol of the Second Component is Different from Polyvinyl Alcohol in Example 6)

### Preparation of Polymer Solution III (Second Component)

In a 300 mL beaker whose tare weight was premeasured, 20 g of ultrapure water was put, and heated and agitated. At a liquid temperature of 80 to 90° C., 0.50 g of polyvinyl alcohol (abbreviated as PVA 1000CH, degree of polymerization 1000, completely saponified. Trade name; Polyvinyl alcohol 1000, completely saponified, Wako Pure Chemical Industries, Ltd.) was put in the beaker little by little, and dispersed uniformly. Agitation was continued while keeping the liquid temperature at 80 to 90° C. until a uniform solution was formed. After agitation for 20 minutes, ultrapure water was added for weight of an aqueous solution to be 50.00 g, and agitation was continued for further 10 minutes at room temperature until a uniform solution was formed, and thus 1.0 wt. % aqueous polymer solution III was prepared.

### Preparation of a Coating Forming Composition

First, 4.80 g of base solution I, 0.20 g of a surfactant solution, 1.08 g of ultrapure water and 1.20 g of polymer solution III were weighed and agitated until a uniform solution was obtained. Subsequently, 0.36 g of crosslinking agent solution I containing 1.0 wt. % solid and 0.36 g of second crosslinking agent solution I containing 1.0 wt. % solid were added, the resultant solution was agitated until a uniform solution was obtained, and thus a coating forming composition of a composition described below was obtained. The prepared coating forming composition had a viscosity of 30.9 mPa·s, and showed a good dispersibility.

| | | |
|---|---|---|
| Silver nanowire | 0.15% | by weight |
| HPMC | 0.3% | by weight |
| PVA 1000CH | 0.15% | by weight |
| Nikalac MW-22 | 0.045% | by weight |
| Orgatix TC-300 | 0.045% | by weight |
| Triton X-100 | 0.025% | by weight |
| IPA | 4.5% | by weight |
| Water | 94.785% | by weight |

In addition, the total weight of HPMC and PVA corresponded to 300 parts by weight based on 100 parts by weight of silver nanowires, Orgatix corresponded to 10 parts by weight based on 100 parts by weight of the total weight of HPMC and PVA, and Nikalac corresponded to 10 parts by weight based on 100 parts by weight of the total weight of HPMC and PVA.

A transparent conductive film was prepared according to procedures similar to Example 1. The transparent conductive film obtained had a surface resistance value of 22.4Ω/□, a total transmittance of 91.3%, a haze of 2.2% and a film thickness of 98 nanometers. Moreover, Environmental reliability, suitability for process, adhesion and hardness were good. Furthermore, Environmental reliability, suitability for process, adhesion and hardness were good also on silicon nitride and an overcoat (product name: PIG-7414, JNC Corporation).

### Example 8

(Composition Containing Hydroxypropyl Methyl Cellulose and Polyvinyl Alcohol (Second Component), (Ammonium Lactate)Titanium Neutralized Product (Third Component), and Hexamethoxymethylolmelamine (Fourth Component), Polyvinyl Alcohol of the Second Component is Different from Polyvinyl Alcohol in Examples 6 and 7)

### Preparation of Polymer Solution IV (Second Component)

In a 300 mL beaker whose tare weight was premeasured, 20 g of ultrapure water was put, and heated and agitated. At a liquid temperature of 80 to 90° C., 0.50 g of polyvinyl alcohol (abbreviated as PVA 1000PH, degree of polymerization 1000, partially saponified. Trade name; Polyvinyl alcohol 1000, partially saponified, Wako Pure Chemical Industries, Ltd.) was put in the beaker little by little, and dispersed uniformly. Agitation was continued while keeping the liquid temperature at 80 to 90° C. until a uniform solution was formed. After agitation for 20 minutes, ultrapure water was added for weight of an aqueous solution to be 50.00 g, and agitation was continued for further 10 minutes at room temperature until a uniform solution was formed, and thus 1.0 wt. % aqueous polymer solution IV was prepared.

### Preparation of a Coating Forming Composition

First, 4.80 g of base solution I, 0.20 g of a surfactant solution, 1.08 g of ultrapure water and 1.20 g of polymer solution IV were weighed and agitated until a uniform solution was obtained. Subsequently, 0.36 g of crosslinking agent solution I containing 1.0 wt. % solid and 0.36 g of second crosslinking agent solution I containing 1.0 wt. % solid were added, the resultant solution was agitated until a uniform solution was obtained, and thus a coating forming composition of a composition described below was obtained. The prepared coating forming composition had a viscosity of 30.9 mPa·s, and showed a good dispersibility.

| | | |
|---|---|---|
| Silver nanowire | 0.15% | by weight |
| HPMC | 0.3% | by weight |
| PVA 1000CH | 0.15% | by weight |
| Nikalac MW-22 | 0.045% | by weight |
| Orgatix TC-300 | 0.045% | by weight |
| Triton X-100 | 0.025% | by weight |
| IPA | 4.5% | by weight |
| Water | 94.785% | by weight |

In addition, the total weight of HPMC and PVA corresponded to 300 parts by weight based on 100 parts by weight of silver nanowires, Orgatix corresponded to 10 parts by weight based on 100 parts by weight of the total weight of HPMC and PVA, and Nikalac corresponded to 10 parts by weight based on 100 parts by weight of the total weight of HPMC and PVA.

A transparent conductive film was prepared according to procedures similar to Example 1. The transparent conductive film obtained had a surface resistance value of 22.5Ω/□, a total transmittance of 91.4%, a haze of 2.4% and a film thickness of 99 nanometers. Moreover, Environmental reliability, suitability for process, adhesion and hardness were good.

### Example 9

(Composition Containing Hydroxypropyl Methyl Cellulose and Polyvinyl Alcohol (Second Component), (Ammonium Lactate) Titanium Neutralized Product (Third Component), Hexamethoxymethylolmelamine (Fourth Component), and a Catalyst (Additional Component). Example 6 to which a Catalyst was Added.)

### Preparation of Catalyst I (Additional Component)

First, 0.20 g of NACURE3525 (trade name) (sulfonate catalyst, KING INDUSTRIES, INC.) was weighed, and diluted with 49.8 g of ultrapure water. Thus, 0.1 wt. % catalyst aqueous solution I was prepared.

### Preparation of a Coating Forming Composition

First, 4.80 g of base solution I, 0.20 g of a surfactant solution, 1.08 g of ultrapure water and 1.20 g of polymer solution II were weighed and agitated until a uniform solution was obtained. Subsequently, 0.36 g of crosslinking agent solution I containing 1.0 wt. % solid and 0.36 g of second crosslinking agent solution I containing 1.0 wt. % solid and 0.72 g of catalyst aqueous solution I containing 0.1 wt. % solid were added, the resultant solution was agitated until a uniform solution was obtained, and thus a coating forming composition of a composition described below was obtained. The prepared coating forming composition had a viscosity of 31.4 mPa·s, and showed a good dispersibility.

| | | |
|---|---|---|
| Silver nanowire | 0.15% | by weight |
| HPMC | 0.3% | by weight |
| PVA 500 CH | 0.15% | by weight |
| Nikalac MW-22 | 0.045% | by weight |
| Orgatix TC-300 | 0.045% | by weight |
| NACURE3525 | 0.009% | by weight |
| Triton X-100 | 0.025% | by weight |
| IPA | 4.5% | by weight |
| Water | 94.776% | by weight |

In addition, the total weight of HPMC and PVA corresponded to 300 parts by weight based on 100 parts by weight of silver nanowires, Orgatix corresponded to 10 parts by weight based on 100 parts by weight of the total weight of HPMC and PVA, and Nikalac corresponded to 10 parts by weight based on 100 parts by weight of the total weight of HPMC and PVA.

A transparent conductive film was prepared according to procedures similar to Example 1. The transparent conductive film obtained had a surface resistance value of 25.0Ω/□, a total transmittance of 91.2%, a haze of 2.2% and a film thickness of 97 nanometers. Moreover, Environmental reliability, suitability for process, adhesion and hardness were good. Furthermore, Environmental reliability, suitability for process, adhesion and hardness were good also on silicon nitride and an overcoat (product name: PIG-7414, JNC Corporation).

### Example 10

(Composition Containing Hydroxypropyl Methyl Cellulose and Polyvinyl Alcohol (Second Component), (Ammonium Lactate)Titanium Neutralized Product (Third Component), and Hexamethoxymethylolmelamine (Fourth Component). Applied onto a PET Film.)

### Preparation of a Coating Forming Composition

First, 2.00 g of base solution I, 0.08 g of a surfactant solution, 7.02 g of ultrapure water and 0.50 g of polymer solution II were weighed and agitated until a uniform solution was obtained. Subsequently, 0.20 g of crosslinking agent solution I containing 1.0 wt. % solid and 0.20 g of second crosslinking agent solution I containing 1.0 wt. % solid were added, the resultant solution was agitated until a uniform solution was obtained, and thus a coating forming composition of a composition described below was obtained. The prepared coating forming composition had a viscosity of 11.1 mPa·s, and showed a good dispersibility.

| | | |
|---|---|---|
| Silver nanowire | 0.05% | by weight |
| HPMC | 0.1% | by weight |
| PVA 500CH | 0.05% | by weight |
| Nikalac MW-22 | 0.02% | by weight |
| Orgatix TC-300 | 0.02% | by weight |
| Triton X-100 | 0.008% | by weight |
| IPA | 2.0% | by weight |
| Water | 97.752% | by weight |

In addition, the total weight of HPMC and PVA corresponded to 300 parts by weight based on 100 parts by weight of silver nanowires, Orgatix corresponded to 13 parts by weight based on 100 parts by weight of the total weight of HPMC and PVA, and Nikalac corresponded to 13 parts by weight based on 100 parts by weight of the total weight of HPMC and PVA.

### Preparation of a Transparent Conductive Film

A coating forming composition was added dropwise on an easily-adhering side of Cosmoshine A4100 (a PET film one side of which was treated to be easily adhering, 125 micrometers in thickness, trade name; Toyobo Co., Ltd.), and applied using a bar coater. Pre-bake of the PET film was performed on a hot stage at 50° C. under conditions for 10 minutes, and then post-bake was performed for 30 minutes on the hot stage at 80° C., and thus a transparent conductive film was prepared.

The transparent conductive film obtained had a surface resistance value of 30.1Ω/□, a total transmittance of 90.7% and a haze of 2.0%. Moreover, hardness was good.

### Example 11

(Composition Containing Hydroxypropyl Methyl Cellulose and Polyvinyl Alcohol (Second Component), (Ammonium Lactate) Titanium Neutralized Product (Third Component), Hexamethoxymethylolmelamine (Fourth Component), and a Catalyst (Additional Component). Applied onto a PET Film.)

### Preparation of a Coating Forming Composition

First, 4.80 g of base solution I, 0.20 g of a surfactant solution, 1.08 g of ultrapure water and 1.20 g of polymer solution II were weighed and agitated until a uniform solution was obtained. Subsequently, 0.36 g of crosslinking agent solution I containing 1.0 wt. % solid, 0.36 g of second crosslinking agent solution I containing 1.0 wt. % solid and 0.72 g of a catalyst aqueous solution I containing 0.1 wt. % solid were added, the resultant solution was agitated until a uniform solution was obtained, and thus a coating forming composition of a composition described below was obtained. The prepared coating forming composition had a viscosity of 25.0 mPa·s and showed a good dispersibility.

| | | |
|---|---|---|
| Silver nanowire | 0.10% | by weight |
| HPMC | 0.2% | by weight |
| PVA 500CH | 0.10% | by weight |
| Nikalac MW-22 | 0.030% | by weight |
| Orgatix TC-300 | 0.030% | by weight |
| NACURE3525 | 0.006% | by weight |
| Triton X-100 | 0.005% | by weight |
| IPA | 2.0% | by weight |
| Water | 97.529% | by weight |

In addition, the total weight of HPMC and PVA corresponded to 300 parts by weight based on 100 parts by weight of silver nanowires, Orgatix corresponded to 10 parts by weight based on 100 parts by weight of the total weight of HPMC and PVA, and Nikalac corresponded to 10 parts by weight based on 100 parts by weight of the total weight of HPMC and PVA.

A transparent conductive film was prepared according to procedures similar to Example 10. The transparent conductive film obtained had a surface resistance value of 17.0Ω/□, a total transmittance of 87.9% and a haze of 3.4%. Moreover, suitability for process and hardness were good.

### Example 12

### (Composition Containing Hydroxypropyl Methyl Cellulose and Polyvinyl Alcohol Having an Acetoacetyl Group (Second Component), (Ammonium Lactato) Titanium Neutralized Product (Third Component), and a Catalyst (Additional Component))

### Preparation of Polymer Solution V (Second Component)

First, 0.50 g of Gohsefimer Z-200 (polyvinyl alcohol having an acetoacetyl group, trade name; The Nippon Synthetic Chemical Industry Co., Ltd.) was weighed and diluted with 49.50 g of ultrapure water, and thus 1.0 wt. % polymer aqueous solution V was prepared.

### Preparation of a Coating Forming Composition

First, 4.80 g of base solution I, 0.20 g of a surfactant solution, 1.08 g of ultrapure water and 1.20 g of polymer solution V were weighed and agitated until a uniform solution was obtained. Subsequently, 0.36 g of crosslinking agent solution I containing 1.0 wt. % solid and 0.36 g of catalyst aqueous solution I containing 0.1 wt. % solid were added, the resultant solution was agitated until a uniform solution was obtained, and thus a coating forming composition of a composition described below was obtained. The prepared coating forming composition had a viscosity of 32.4 mPa·s, and showed a good dispersibility.

| | | |
|---|---|---|
| Silver nanowire | 0.15% | by weight |
| HPMC | 0.3% | by weight |
| Gohsefimer Z-200 | 0.15% | by weight |
| Orgatix TC-300 | 0.045% | by weight |
| NACURE3525 | 0.0045% | by weight |
| Triton X-100 | 0.025% | by weight |
| Water | 97.3255% | by weight |

In addition, the total weight of HPMC and Gohsefimer Z-200 corresponded to 300 parts by weight based on 100 parts by weight of silver nanowires, and Orgatix corresponded to 10 parts by weight based on 100 parts by weight of the total weight of HPMC and Gohsefimer 2200.

A transparent conductive film was prepared according to procedures similar to Example 1. The transparent conductive film obtained had a surface resistance value of 27.6Ω/□, a total transmittance of 90.7%, a haze of 2.1% and a film thickness of 100 nanometers. Moreover, suitability for process, adhesion and hardness were good. Furthermore, suitability for process and hardness were good also on silicon nitride and an overcoat (product name: PIG-7414, JNC Corporation). In particular, changes of a surface resistance value, total transmittance and haze after a suitability for process test was within 20% compared with the values before suitability for process tests, and thus suitability for process was very good.

### Example 13

### (Composition Containing Hydroxypropyl Methyl Cellulose and Polyvinyl Acetal (Second Component), (Ammonium Lactate) Titanium Neutralized Product (Third Component), and a Catalyst (Additional Component))

### Preparation of Polymer Solution VI (Second Component)

First, 1.04 g of S-Lec KW-10 (trade name) (polyvinyl acetal (having a hydroxyl group), 24.1 wt. % solid concentration, Sekisui Chemical Co., Ltd.) was weighed and diluted with 23.96 g of ultrapure water, and thus 1.0 wt. % polymer aqueous solution VI was prepared.

### Preparation of a Coating Forming Composition

First, 4.80 g of base solution I, 0.20 g of a surfactant solution, 1.08 g of ultrapure water and 1.20 g of polymer solution VI were weighed and agitated until a uniform solution was obtained. Subsequently, 0.36 g of crosslinking agent solution I containing 1.0 wt. % solid and 0.36 g of catalyst aqueous solution I containing 0.1 wt. % solid were added, the resultant solution was agitated until a uniform solution was obtained, and thus a coating forming composition of a composition described below was obtained. The prepared coating forming composition had a viscosity of 31.1 mPa·s, and showed a good dispersibility.

| | | |
|---|---|---|
| Silver nanowire | 0.15% | by weight |
| HPMC | 0.3% | by weight |
| S-Lec KW-10 | 0.15% | by weight |
| Orgatix TC-300 | 0.045% | by weight |
| NACURE3525 | 0.0045% | by weight |
| Triton X-100 | 0.025% | by weight |
| Water | 99.3255% | by weight |

In addition, the total weight of HPMC and S-Lec KW-10 corresponded to 300 parts by weight based on 100 parts by weight of silver nanowires, and Orgatix corresponded to 10 parts by weight based on 100 parts by weight of the total weight of HPMC and S-Lec KW-10.

A transparent conductive film was prepared according to procedures similar to Example 1. The transparent conductive film obtained had a surface resistance value of 33.1Ω/□, a total transmittance of 90.9%, a haze of 2.4% and a film thickness of 100 nanometers. Moreover, suitability for process, adhesion and hardness were good. Furthermore, suitability for process and hardness were good also on silicon nitride and an overcoat (product name: PIG-7414, JNC Corporation). In particular, changes of a surface resistance value, total transmittance and haze after a suitability for process test was within 20% compared with the values before suitability for process tests, and thus suitability for process was very good.

### Comparative Example 1

### (Composition Containing HPMC but Neither Third Component Nor Fourth Component)

### Preparation of a Coating Forming Composition

First, 4.80 g of base solution I, 0.20 g of a surfactant solution and 4.00 g of ultrapure water were weighed and agitated until a uniform solution was obtained. The prepared coating forming composition had a viscosity of 31.4 mPa·s and showed a good dispersibility.

| | | |
|---|---|---|
| Silver nanowire | 0.15% | by weight |
| HPMC | 0.3% | by weight |
| Triton X-100 | 0.025% | by weight |
| Water | 99.525% | by weight |

In addition, HPMC corresponded to 200 parts by weight based on 100 parts by weight of silver nanowires.

A transparent conductive film was prepared according to procedures similar to Example 1. The transparent conductive film obtained had a surface resistance value of 27.2Ω/□, a total transmittance of 91.0%, a haze of 1.9% and a film thickness of 50 nanometers. Moreover, Environmental reliability, suitability for process, adhesion and hardness were poor.

### Comparative Example 2

### (Composition Containing PVA but Neither Third Component Nor Fourth Component)

### Preparation of a Coating Forming Composition

First, 4.80 g of base solution II, 0.20 g of a surfactant solution and 4.00 g of ultrapure water were weighed and agitated until a uniform solution was obtained, and thus a coating forming composition of a composition described below was obtained. The prepared coating forming composition had a viscosity of 26.2 mPa·s and showed a good dispersibility.

| | | |
|---|---|---|
| Silver nanowire | 0.15% | by weight |
| PVA 500CH | 0.3% | by weight |
| Triton X-100 | 0.025% | by weight |
| Water | 99.525% | by weight |

In addition, PVA corresponded to 200 parts by weight based on 100 parts by weight of silver nanowires.

A transparent conductive film was prepared according to procedures similar to Example 1. The transparent conductive film obtained had a surface resistance value of 70.2Ω/□, a total transmittance of 92.0%, a haze of 1.0% and a film thickness of 41 nanometers. Moreover, Environmental reliability, suitability for process, adhesion and hardness were poor.

TABLE 1

| | Conductivity | Transparency | | | |
|---|---|---|---|---|---|
| | Surface | Total | | Suit- | |
| | Resistance | Luminous | | ability | |
| Sample | Value | Transmit- | Haze | for | |
| Name | [Ω/□] | tance [%] | [[%] | process | Hardness |
| Example 1 | 26.0 | 90.1 | 1.9 | Good | Marginal |
| Example 2 | 45.6 | 90.2 | 2.1 | Good | Good |
| Example 3 | 24.8 | 90.2 | 1.9 | Excellent | Good |
| Example 4 | 24.4 | 90.4 | 1.9 | Excellent | Good |
| Example 5 | 26.6 | 91.7 | 2.4 | Excellent | Excellent |
| Example 6 | 41.8 | 92.6 | 1.3 | Excellent | Excellent |
| Example 7 | 22.4 | 91.3 | 2.2 | Excellent | Excellent |
| Example 8 | 22.5 | 91.4 | 2.4 | Excellent | Excellent |
| Example 9 | 25.0 | 91.2 | 2.2 | Excellent | Excellent |
| Example 10 | 30.1 | 90.7 | 2.0 | Excellent | Good |
| Example 11 | 17.0 | 87.9 | 3.4 | Excellent | Good |
| Example 12 | 27.6 | 90.7 | 2.1 | Excellent | Excellent |
| Example 13 | 33.1 | 90.9 | 2.4 | Excellent | Excellent |
| Comparative | 27.2 | 91.0 | 1.9 | Bad | Bad |
| Example 1 | | | | | |
| Comparative | 70.2 | 92.0 | 1.0 | Bad | Bad |
| Example 2 | | | | | |

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

### INDUSTRIAL APPLICABILITY

The coating forming composition for the transparent conductive films of the invention can be used for a manufacturing process of devices, such as a liquid crystal display device, an organic electroluminescence device, electronic paper, a touch panel device and a solar battery device, for example.

What is claimed is:

1. A coating forming composition, comprising:
at least one kind selected from the group of metal nanowires and metal nanotubes as a first component;
a polymer compound having a hydroxyl group as a second component;
at least one kind selected from hydroxide containing a group 13 element or a transition metal element, acylate containing a group 13 element or a transition metal element, alkoxide containing a group 13 element or a transition metal element and a complex containing a group 13 element or a transition metal element as a third component; and
a solvent.

2. The coating forming composition according to claim 1, wherein the third component is at least one kind selected from the group of alkoxide containing a transition metal element, acylate containing a transition metal element and a complex containing a transition metal element.

3. The coating forming composition according to claim 2, wherein the transition metal of the third component is titanium.

4. The coating forming composition according to claim 1, wherein the second component is at least one kind selected from the group of a homopolymer of vinyl alcohol and a copolymer thereof, a homopolymer of hydroxyalkyl(meth)acrylate and a copolymer thereof, a homopolymer of hydroxyalkyl(meth)acrylamide and a copolymer thereof, and polysaccharides and a derivative thereof.

5. The coating forming composition according to claim 4, wherein the second component contains at least one kind selected from the group of polysaccharides and a derivative thereof, and a homopolymer of vinyl alcohol and a copolymer thereof.

6. The coating forming composition according to claim 5, wherein the second component contains at least one kind selected from the group of polysaccharides and a derivative thereof, and at least one kind selected from the group of a homopolymer of vinyl alcohol and a copolymer thereof.

7. The coating forming composition according to claim 1, wherein the first component is in the range of 0.01% by weight to 1.0% by weight, the second component is in the range of 0.0050% by weight to 5.0% by weight, the third component is in the range of 0.000050% by weight to 5.0% by weight, and the solvent is in the range of 89.0% by weight to 99.98% by weight, based on the total weight of the coating forming composition.

8. The coating forming composition according to claim 1, further comprising at least one kind selected from the group of an isocyanate compound, an epoxy compound, an aldehyde compound, an amine compound and a methylol compound, as a fourth component.

9. The coating forming composition according to claim 8, containing a methylol compound as the fourth component.

10. The coating forming composition according to claim 8, wherein the first component is in the range of 0.01% by weight to 1.0% by weight, the second component is in the range of 0.0050% by weight to 5.0% by weight, the third component is in the range of 0.000050% by weight to 5.0% by weight, the fourth component is in the range of 0.000050% by weight to 5.0% by weight, and the solvent is in the range of 84.0% by weight to 99.98% by weight, based on the total weight of the coating forming composition.

11. The coating forming composition according to claim 1, wherein the first component is silver nanowires.

12. The coating forming composition according to claim 1, used for forming a coating having conductivity.

13. A substrate having a transparent conductive film obtained using the coating forming composition according to claim 12, wherein a thickness of the transparent conductive film is in the range of 5 nanometers to 500 nanometers, a surface electrical resistance of the transparent conductive film is in the range of 10Ω/□ to 5,000Ω/□, and a total transmittance of the transparent conductive film is 85% or more.

14. A device element, using the substrate according to claim 13.
